(19) United States
(12) Patent Application Publication
(10) Pub. No.: US 2022/0091252 A1
(43) Pub. Date: Mar. 24, 2022

(54) MOTION STATE DETERMINING METHOD AND APPARATUS

(71) Applicant: HUAWEI TECHNOLOGIES CO., LTD., Shenzhen (CN)

(72) Inventors: Jianguo WANG, Beijing (CN); Xuzhen WANG, Beijing (CN)

(73) Assignee: HUAWEI TECHNOLOGIES CO., LTD., Shenzhen (CN)

(21) Appl. No.: 17/542,991

(22) Filed: Dec. 6, 2021

Related U.S. Application Data
(63) Continuation of application No. PCT/CN2020/094020, filed on Jun. 2, 2020.

(30) Foreign Application Priority Data
Jun. 6, 2019 (CN) 201910493764.1

(51) Int. Cl. G01S 13/58

(52) U.S. Cl. CPC G01S 13/584

(57) ABSTRACT

A motion state determining method and apparatus are provided. The method includes determining a weight of a grid cell in a velocity grid W₁ based on the measurement data obtained from a sensor, where the velocity grid W₁ includes a plurality of grid cells. Each grid cell in the plurality of grid cells corresponds to one velocity vector, each velocity vector includes at least one velocity component, and the measurement data includes a velocity measurement value. The method further includes determining a motion state of the sensor based on the weight of the grid cell, where the motion state of the sensor includes a velocity vector of the sensor, and the velocity vector of the sensor includes at least one velocity component. The motion state determining method disclosed herein allows the motion state of the sensor to be accurately determined.

### CROSS-REFERENCE TO RELATED APPLICATIONS

This application is a continuation of International Application No. PCT/CN2020/094020, filed on Jun. 2, 2020, which claims priority to Chinese Patent Application No. 201910493764.1, filed on Jun. 6, 2019. The disclosures of the aforementioned applications are hereby incorporated by reference in their entireties.

### TECHNICAL FIELD

This application relates to the field of sensor technologies, and in particular, to a motion state determining method and apparatus.

### BACKGROUND

A variety of sensors, such as radar, sonar, ultrasonic sensors, and visual sensors including cameras, are usually configured in an advanced driver assistant system (ADAS) or autonomous driving (AD) system, to “perceive” an ambient environment and target information. By using the information obtained by these sensors, functions such as classification, recognition and tracking of the ambient environment and objects can be implemented. The platforms that utilize these sensors include a vehicle, ship-borne, airborne, or satellite-borne system. These sensors are deployed on the sensor platforms and can provide measurement data of targets moving relative to a reference system or targets stationary relative to the reference system around a mobile device. The reference system may be the earth or an inertial coordinate system relative to the earth. For example, the targets moving relative to the reference system may be vehicles, pedestrians, and the like. The targets stationary relative to the reference system may be obstacles, guardrails, curbs, lamp poles, surrounding trees, buildings, and the like. The measurement data may include one or more of the distance of the target relative to the sensor, an azimuth angle of the target relative to the sensor, a pitch angle of the target relative to the sensor, a radial velocity of the target relative to the sensor, and a scattering cross section of the target relative to the sensor.

Compared to a sensor at a fixed position, the motion of a sensor deployed on the mobile device will cause the following effects: First, the targets moving relative to the reference system and the targets stationary relative to the reference system are usually analyzed and processed using different methods. The targets moving relative to the reference system usually need to be classified, recognized, and tracked. The targets stationary relative to the reference system usually need to be classified and recognized, to provide additional information for autonomous driving, such as obstacles and drivable areas. The motion of the sensor will make it impossible to distinguish the targets moving relative to the reference system from the targets stationary relative to the reference system, which then makes it impossible to analyze and process the targets moving relative to the reference system and the targets stationary relative to the reference system using the different methods. Second, the tracking of the targets moving relative to the reference system is usually model based. A conventional target motion model is usually defined relative to a ground plane or geodetic coordinate system. The motion of the sensor will lead to errors in the conventional model or degradation of tracking performance. Therefore, it is necessary to estimate the motion state of the sensors, especially its velocity, to compensate for the above-described impact.

In the conventional technology, manners of obtaining the motion state of the sensor include the following two methods. (1) A position of the vehicle is obtained by using a global navigation satellite system (global navigation satellite system, GNSS), such as a global positioning system (global positioning system, GPS), and a motion state of the vehicle is obtained based on specific positions at a plurality of time points. However, the precision of a civil GNSS is low and is usually in a meter scale, and often there are large errors. (2) A velocity vector of the sensor is measured by using an inertial measurement unit (IMU) on the mobile device. However, the velocity vector measured by the IMU is usually obtained based on an accelerated velocity measured by an accelerometer, and the measurement errors will accumulate over time. In addition, an accelerometer is susceptible to electromagnetic interference. Therefore, how to accurately determine the motion state of a sensor, especially the velocity vector of the sensor, is an urgent problem to be solved.

### SUMMARY

Embodiments of this application provide a motion state determining method and apparatus for accurately determining a motion state of a sensor.

According to a first aspect, an embodiment of this application provides a motion state determining method. The method includes: determining a weight of a grid cell in a velocity grid W₁ based on measurement data from a sensor, where the velocity grid W₁ includes a plurality of grid cells, each grid cell in the plurality of grid cells corresponds to one velocity vector, each velocity vector includes at least one velocity component, and the measurement data includes a velocity measurement value; and determining a motion state of the sensor based on the weight of the grid cell, where the motion state of the sensor includes a velocity vector of the sensor, and the velocity vector of the sensor includes at least one velocity component. According to the method described in the first aspect, the velocity vector of the sensor may be accurately determined based on the measurement data from the sensor.

Optionally, in addition to the velocity vector of the sensor, the motion state of the sensor may further include a position of the sensor. For example, the position of the sensor may be obtained based on the velocity vector and a time interval by using a specified start time point or an initial position as a reference.

In an optional implementation, the velocity grid W₁ is determined based on at least one of a resolution cell size and a reference velocity vector. Specifically, the velocity grid W₁ is determined based on at least one of the reference velocity vector and a resolution cell size of the velocity grid W₁ in each dimension direction.

Optionally, the velocity grid W₁ may be determined based on at least one of the resolution cell size and the reference velocity vector, and based on at least one of a resolution cell quantity, a minimum velocity of a velocity component, and a velocity range of the velocity component. Specifically, the velocity grid W₁ is determined based on at least one of the reference velocity vector and the resolution cell size of the velocity grid W₁ in each dimension direction, and at least one of a resolution cell quantity of the velocity grid W₁ in each dimension direction, a minimum velocity of each velocity component of the velocity grid W₁, and a velocity range of the velocity component of the velocity grid W₁.

Optionally, the velocity grid W₁ may be used to determine the velocity vector of the sensor, where a grid cell in the velocity grid W₁ corresponds to a candidate velocity vector of the sensor; or the velocity grid W₁ may be used to determine a sensor-measured velocity of a target stationary relative to a reference system, where a grid cell in the velocity grid W₁ corresponds to a candidate velocity vector of the target stationary relative to the reference system. For example, in a vehicle or unmanned aerial vehicle sensor, the reference system may be a geodetic coordinate system, or an inertial coordinate system moving uniformly relative to the earth, and the target stationary relative to the reference system may be an object in an ambient environment, such as a guardrail, a curb, a lamp pole, or a building.

In an optional implementation, determining the velocity vector of the sensor based on the weight of the grid cell comprises: determining the motion state of the sensor based on a first grid cell in the velocity grid W₁, where the first grid cell in the velocity grid W₁ is a grid cell with a largest weight in the velocity grid W₁, the first grid cell in the velocity grid W₁ is a grid cell that is in a neighborhood of a grid cell with a largest weight in the velocity grid W₁ and that is closest to the reference velocity vector, or the first grid cell in the velocity grid W₁ is a grid cell that is among a plurality of grid cells with maximum weights in the velocity grid W₁ and that corresponds to a velocity vector closest to the reference velocity vector. The grid cells with maximum weights may be grid cells whose weights are greater than a threshold, or the grid cells with maximum weights may be grid cells whose weight sizes are sorted before a preset position. According to this implementation, the motion state of the sensor can be accurately determined based on a velocity vector corresponding to the first grid cell in the velocity grid W₁.

In an optional implementation, the determining of the weight of the grid cell in the velocity grid W₁ based on the measurement data from the sensor comprises: determining a second grid cell (i, j) based on an n^{th} piece of measurement data, and weighting the second grid cell (i, j) based on a weighted increment or weighting factor, where a velocity vector corresponding to the second grid cell (i, j) satisfies

|vₓ(i)·cosθₙ+v_{y}(j)·sinθₙ+\dot{r}ₙ|≤T₁; or

determining a second grid cell (i, j, k) based on an n^{th} piece of measurement data, and weighting the second grid cell (i, j, k) based on a weighted increment or weighting factor, where a velocity vector corresponding to the second grid cell (i, j, k) satisfies

|vₓ(i)·cosφₙcosθₙ+v_{y}(j)·sinφₙsinφₙ+v_{z}(k)·sinφₙ+\dot{r}ₙ|≤T₂, where

θₙ is a measurement value of an azimuth angle included in the n^{th} piece of measurement data, φₙ is a measurement value of a pitch angle included in the n^{th} piece of measurement data, \dot{r}ₙ is a measurement value of a radial velocity included in the n^{th} piece of measurement data, vₓ (i) is an x-axis component of the velocity vector corresponding to the second grid cell, vⱼ (j) is a y-axis component of the velocity vector corresponding to the second grid cell, v_{z} (k) is a z-axis component of the velocity vector of the second grid cell, and both T₁ and T₂ are non-negative thresholds. According to the optional implementation, only the second grid cell is weighted, and other low-probability grid cells are ignored, to effectively reduce the quantity of grid cells whose weighted increments or weighting factors need to be calculated, and effectively reduce the calculation amount.

In an optional implementation, the determining of the weight of the grid cell in the velocity grid W₁ based on the measurement data from the sensor comprises: determining a second grid cell (i, j) based on an n^{th} piece of measurement data, and weighting the second grid cell (i, j) based on a weighted increment or weighting factor, where a velocity vector corresponding to the second grid cell (i, j) satisfies

|vₓ(i)·cosθₙ+v_{y}(j)·sinθₙ−\dot{r}ₙ≤T₁; or

determining a second grid cell (i, j, k) based on an n^{th} piece of measurement data, and weighting the second grid cell (i, j, k) based on a weighted increment or weighting factor, where a velocity vector corresponding to the second grid cell (i, j, k) satisfies

|vₓ(i)·cosφₙcosθₙ+v_{y}(j)·sinφₙsinθₙ+v_{z}(k)·sinφₙ−\dot{r}ₙ|≤T₂, where

θₙ is a measurement value of an azimuth angle included in the n^{th} piece of measurement data, φₙ is a measurement value of a pitch angle included in the n^{th} piece of measurement data, \dot{r}ₙ is a measurement value of a radial velocity included in the n^{th} piece of measurement data, vₓ (i) is an x-axis component of the velocity vector corresponding to the second grid cell, vⱼ (j) is a y-axis component of the velocity vector corresponding to the second grid cell, v_{z} (k) is a z-axis component of the velocity vector of the second grid cell, and both T₁ and T₂ are non-negative thresholds. According to the optional implementation, only the second grid cell may be weighted, and other low-probability grid cells are ignored, to effectively reduce the quantity of grid cells whose weighted increments or weighting factors need to be calculated, and effectively reduce the calculation amount.

Optionally, for one piece of measurement data from the sensor, one weighted increment may be determined for one grid cell in the velocity grid W₁, and a weight of the grid cell in the velocity grid W₁ is determined by accumulating weighted increments corresponding to one or more pieces of measurement data from the sensor. In this case, the weight of the grid cell is obtained in a cumulative sum form. Optionally, for one piece of measurement data from the sensor, one weighting factor may be determined for one grid cell in the velocity grid W₁, and a weight of the grid cell in the velocity grid W₁ is determined by multiplying weighting factors corresponding to one or more pieces of measurement data from the sensor. In this case, the weight of the grid cell is obtained in a product form. That is, the grid cell may be weighted in a weighted increment form, or may be weighted in the product form.

In an optional implementation, the weighted increment or weighting factor of the grid cell in the velocity grid W₁ is a preset value, the weighted increment or weighting factor of the grid cell in the velocity grid W₁ is a value determined based on the n^{th} piece of measurement data, or the weighted increment or weighting factor of the grid cell in the velocity grid W₁ is a value determined based on the n^{th} piece of measurement data and a distribution of a scattering section corresponding to a preset target type. In this way, the weight of the grid cell can be obtained more precisely, and thus the motion state, especially the velocity vector, of the sensor, can be determined more precisely.

In an optional implementation, the first grid cell in the velocity grid W₁ is the grid cell with the largest weight in the velocity grid W₁. When the velocity grid W₁ has a plurality of grid cells with the largest weight, the first grid cell in the velocity grid W₁ is a grid cell that is among the plurality of grid cells with the largest weight and that corresponds to a largest velocity vector, where the largest velocity vector refers to a velocity vector with a maximum norm or a maximum speed. The norm may be a Euclidean norm or a norm of another type. Alternatively, when the velocity grid W₁ has a plurality of grid cells with the largest weight, the first grid cell in the velocity grid W₁ is a grid cell that is among the plurality of grid cells with the largest weight and that corresponds to a velocity vector closest to the reference velocity vector. The velocity vector closest to the reference velocity vector refers to a velocity vector with the smallest distance from the reference velocity vector. The distance may be a Euclidean distance, a Mahalanobis distance, or a distance of another type.

In an optional implementation, the determining of the motion state of the sensor based on the first grid cell in the velocity grid W₁ comprises: determining that a velocity vector corresponding to the first grid cell in the velocity grid W₁ is the velocity vector of the sensor. In this optional implementation, the velocity vector of the first grid cell in the velocity grid W₁ among a plurality of velocity vectors in the velocity grid W₁ is most likely to be the velocity vector of the sensor. Therefore, the velocity vector corresponding to the first grid cell in the velocity grid W₁ may be directly determined as the velocity vector of the sensor.

In an optional implementation, the determining of the motion state of the sensor based on the first grid cell in the velocity grid W₁ comprises: determining that an opposite number of each velocity component of a velocity vector corresponding to the first grid cell in the velocity grid W₁ is each velocity component of the velocity vector of the sensor. In this optional implementation, the velocity vector corresponding to the first grid cell in the velocity grid W₁ among a plurality of velocity vectors in the velocity grid W₁ is most likely to be a velocity vector corresponding to the target stationary relative to the reference system. Because the velocity vector of the sensor and a velocity component of the velocity vector of the target stationary relative to the reference system are the same in magnitude, but opposite in direction, the opposite number of the velocity component of the velocity vector corresponding to the first grid cell in the velocity grid W₁ may be determined as the velocity component of the velocity vector of the sensor.

In an optional implementation, the determining of the motion state of the sensor based on the first grid cell in the velocity grid W₁ comprises: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, and the weight of the grid cell in the velocity grid Wₘ is determined based on the measurement data from the sensor, where m=1, 2, . . . , M, and M is an integer; and determining that a velocity vector corresponding to the first grid cell in the velocity grid W_{M} is the velocity vector of the sensor. In this optional implementation, after a velocity vector corresponding to the first grid cell in the velocity grid W₁ is determined, M−1 iterations are performed to determine the velocity vector of the sensor. According to this optional implementation, the velocity vector of the sensor can be determined more accurately. When M=1, W₀ is a preset initial value and may be set during system initialization.

In an optional implementation, the determining of the motion state of the sensor based on the first grid cell in the velocity grid W₁ comprises: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, and the weight of the grid cell in the velocity grid Wₘ is determined based on the measurement data from the sensor, where m=1, 2, . . . , M, and M is an integer; and determining that an opposite number of each velocity component of a velocity vector corresponding to the first grid cell in the velocity grid W_{M} is each velocity component of the velocity vector of the sensor. In this optional implementation, after a velocity vector corresponding to the first grid cell in the velocity grid W₁ is determined, M−1 iterations are performed to determine the velocity vector of the sensor. According to this optional implementation, the velocity vector of the sensor can be determined more accurately.

In an optional implementation, after the velocity vector of the sensor is determined, the measurement data of the target stationary relative to the reference system may be further determined based on the velocity vector of the sensor from the measurement data. According to this optional implementation, the measurement data of a target moving relative to the reference system and the measurement data of the target stationary relative to the reference system can be separated.

In an optional implementation, the determining of the motion state of the sensor based on the first grid cell in the velocity grid W₁ comprises: determining, based on the velocity vector corresponding to the first grid cell in the velocity grid W₁, measurement data of the target stationary relative to the reference system from the measurement data; and determining the velocity vector of the sensor based on the measurement data of the target stationary relative to the reference system. According to this optional implementation, the velocity vector of the sensor can be determined accurately.

In an optional implementation, the determining of the velocity vector of the sensor based on the measurement data of the target stationary relative to the reference system comprises: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, the weight of the grid cell in the velocity grid Wₘ is determined based on newly determined measurement data of the target stationary relative to the reference system, and the newly determined measurement data of the target stationary relative to the reference system is determined based on the velocity vector corresponding to the first grid cell in the velocity grid Wₘ₋₁, where m=1, 2, . . . , M, and M is an integer; and determining that a velocity vector corresponding to the first grid cell in the velocity grid W_{M} is the velocity vector of the sensor. In this optional implementation, after the measurement data of the target stationary relative to the reference system is determined based on the velocity vector corresponding to the first grid cell in the velocity grid W₁ from the measurement data, M−1 iterations are performed based on the measurement data of the target stationary relative to the reference system, to determine the velocity vector of the sensor. Therefore, according to this optional implementation, the velocity vector of the sensor can be determined more accurately.

In an optional implementation, the determining of the velocity vector of the sensor based on the measurement data of the target stationary relative to the reference system comprises: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, the weight of the grid cell in the velocity grid Wₘ is determined based on newly determined measurement data of the target stationary relative to the reference system, and the newly determined measurement data of the target stationary relative to the reference system is determined based on the velocity vector corresponding to the first grid cell in the velocity grid Wₘ₋₁, where m=1, 2, . . . , M, and M is an integer; and determining that an opposite number of each velocity component of a velocity vector corresponding to the first grid cell in the velocity grid W_{M} is each velocity component of the velocity vector of the sensor. In this optional implementation, after the measurement data of the target stationary relative to the reference system is determined based on the velocity vector corresponding to the first grid cell in the velocity grid W₁ from the measurement data, M−1 iterations are performed based on the measurement data of the target stationary relative to the reference system, to determine the velocity vector of the sensor. Therefore, according to this optional implementation, the velocity vector of the sensor can be determined more accurately.

In an optional implementation, a specific implementation of determining the velocity vector of the sensor based on the measurement data of the target stationary relative to the reference system comprises: determining the velocity vector of the sensor according to the following measurement equation:

−\dot{r}ₖ=hₖvₛ−n_{\dot{r}}, where

\dot{r}ₖ is a measurement value of a radial velocity of a k^{th} target stationary relative to the reference system, n_{\dot{r}} is a measurement error of the radial velocity, vₛ is the velocity vector of the sensor, vₛ is a two-dimensional vector, and hₖ=[cosθₖ sinθ]; or vₛ is a three-dimensional vector, and hₖ=[cosφₖcosθₖ cosφₖsinθₖ sinφₖ], where θₖ is a measurement value of an azimuth angle of the k^{th} target stationary relative to the reference system, and φₖ is a measurement value of a pitch angle of the k^{th} target stationary relative to the reference system. According to this optional implementation, the velocity vector of the sensor can be determined more accurately.

In an optional implementation, a specific implementation of determining the velocity vector of the sensor based on the measurement data of the target stationary relative to the reference system comprises: determining the velocity vector of the sensor according to the following measurement equation:

\dot{r}ₖ=hₖv_{T}+n_{\dot{r}}, where

\dot{r}ₖ is a measurement value of a radial velocity of a k^{th} target stationary relative to the reference system, v_{T} is a velocity vector of the target stationary relative to the reference system, n_{\dot{r}} is a measurement error of the radial velocity, v_{T} is a two-dimensional vector, and hₖ=[cosθₖ sinθₖ]; or v_{T} is a three-dimensional vector, and hₖ=[cosφₕ cosθₖ cosφₖsinθₖ sinφₖ], where θₖ is a measurement value of an azimuth angle of the k^{th} target stationary relative to the reference system, and φₖ is a measurement value of a pitch angle of the k^{th} target stationary relative to the reference system. The velocity vector vₛ of the sensor can be obtained according to vₛ=−v_{T}. According to this optional implementation, the velocity vector of the sensor can be determined more accurately.

In an optional implementation, a specific implementation of determining the velocity vector of the sensor according to the measurement equation comprises: obtaining the velocity vector of the sensor according to the measurement equation and based on a least square method and/or sequential block filtering. According to this optional implementation, the velocity vector of the sensor can be determined more accurately.

In an optional implementation, a specific implementation of determining the motion state of the sensor based on the first grid cell in the velocity grid W₁ comprises: determining the velocity vector of the sensor based on a velocity vector corresponding to the first grid cell in the velocity grid W₁, a velocity vector corresponding to the first grid cell in the velocity grid Wₘ, or a velocity vector of the sensor estimated based on the measurement data of the target stationary relative to the reference system and a first velocity vector. The first velocity vector includes a velocity vector of the sensor determined based on measurement data of a previous frame and/or a reference velocity vector of the sensor, where the reference velocity vector of the sensor may be a velocity vector of the sensor measured by an IMU or another apparatus. According to this optional implementation, by using a temporal and/or spatial correlation of motion, the velocity vector of the sensor may be determined more accurately based on a reference velocity vector and a velocity vector of the sensor obtained from current measurement data and/or a velocity vector of the sensor determined previously.

According to a second aspect, a motion state determining apparatus is provided. The apparatus may perform the method according to any one of the first aspect and the optional implementations of the first aspect. The functions may be implemented by hardware, or may be implemented by hardware executing corresponding software. The hardware or software includes one or more units corresponding to the foregoing functions. The unit may be software and/or hardware. Based on a same inventive concept, for the same problem-resolving principle and beneficial effects of the motion state determining apparatus, refer to the method and beneficial effects according to any one of the first aspect and the optional implementations of the first aspect described above. Details are not described again.

According to a third aspect, a motion state determining apparatus is provided. The motion state determining apparatus includes a processor and a communication interface. Optionally, the apparatus further includes a memory. The processor, the communication interface, and the memory are interconnected.

In an optional design, the communication interface may be a transceiver or a receiver and a transmitter that are independently disposed. The communication interface is configured to implement communication with another network element.

In another optional design, the communication interface may be an interface circuit, and the interface circuit is used by the processor to obtain or output information or data. For example, the interface circuit is used by the processor to read data from the memory or write data. For another example, the interface circuit is used by the processor to receive information or data outside the apparatus, or send information or data outside the apparatus.

The memory is configured to store a program, and the processor invokes the program stored in the memory, to implement the method according to any one of the first aspect and the optional implementations of the first aspect. For the problem-resolving implementations and beneficial effects of the motion state determining apparatus, refer to the method and beneficial effects according to any one of the first aspect and the optional implementations of the first aspect. Details are not described again.

According to a fourth aspect, a computer program product is provided. When the computer program product runs on a computer, the computer is enabled to perform the methods according to any one of the first aspect and the optional implementations of the first aspect.

According to a fifth aspect, a chip product is provided. The chip product performs the method according to any one of the first aspect and the optional implementations of the first aspect.

According to a sixth aspect, a computer-readable storage medium is provided. The computer-readable storage medium stores instructions; and when the instructions are run on a computer, the computer is enabled to perform the method according to any one of the first aspect and the optional implementations of the first aspect.

### BRIEF DESCRIPTION OF DRAWINGS

FIG. 1 is a schematic diagram of a system architecture according to an embodiment of this application;

FIG. 2 is a schematic diagram of measurement data according to an embodiment of this application;

FIG. 3 is a schematic flowchart of a motion state determining method according to an embodiment of this application;

FIG. 4 is a schematic diagram of a velocity grid according to an embodiment of this application;

FIG. 5 is a schematic diagram of another velocity grid according to an embodiment of this application;

FIG. 6 is a schematic diagram of still another velocity grid according to an embodiment of this application;

FIG. 7 is a schematic flowchart of another motion state determining method according to an embodiment of this application;

FIG. 8 is a schematic diagram of still another velocity grid according to an embodiment of this application;

FIG. 9 is a schematic structural diagram of a motion state determining apparatus according to an embodiment of this application; and

FIG. 10 is a schematic structural diagram of another motion state determining apparatus according to an embodiment of this application.

### DESCRIPTION OF EMBODIMENTS

The following further describes specific embodiments of this application in detail with reference to the accompanying drawings.

The embodiments of this application provide a motion state determining method and a motion state determining apparatus, to accurately determine a motion state, especially a velocity vector, of a sensor.

To better understand the embodiments of this application, the following describes a system architecture applicable to the embodiments of this application.

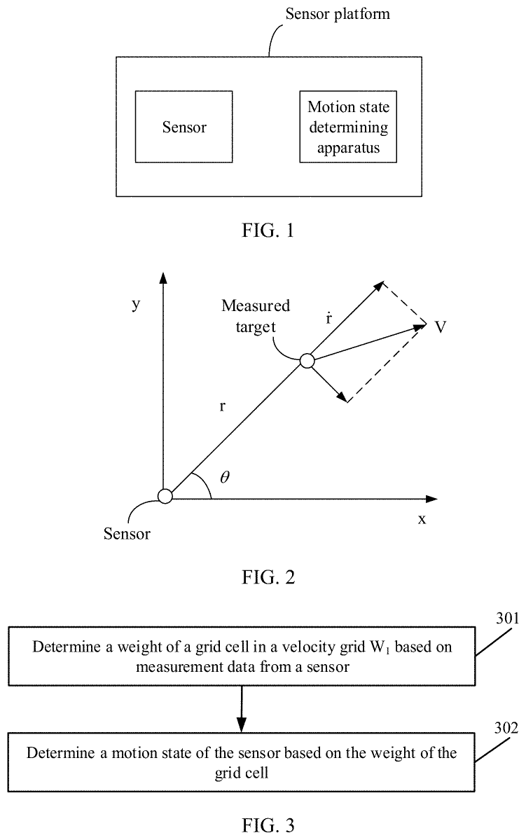

FIG. 1 is a schematic diagram of a system architecture according to an embodiment of this application. As shown in FIG. 1, the system architecture includes a sensor platform. The sensor platform is equipped with a sensor. The system architecture further includes a motion state determining apparatus. The motion state determining apparatus may be deployed on the sensor platform, that is, the motion state determining apparatus may be integrated with the sensor platform. Alternatively, the motion state determining apparatus may be deployed outside the sensor platform, and the motion state determining apparatus communicates with the sensor platform by using a wireless network. FIG. 1 shows an example in which the motion state determining apparatus is deployed on the sensor platform.

The sensor platform may be a mobile device. For example, the sensor platform may be a vehicle platform, such as a car, a motorcycle, or a bicycle. Alternatively, the sensor platform may be a ship-borne platform, such as a ship, a steamer, or a motorboat. Alternatively, the sensor platform may be an airborne platform, such as a drone, a helicopter, a jet aircraft, or a balloon. Alternatively, the sensor platform may be a satellite-borne platform, for example, a satellite.

The sensor may be a radar sensor, for example, a millimeter wave radar or a laser radar. Alternatively, the sensor may be a sonar or ultrasonic sensor. Alternatively, the sensor may be a visual sensor or an imaging sensor, such as a camera, a camera, or an imaging radar such as a laser radar and a synthetic aperture radar. Alternatively, the sensor may be a direction finding sensor capable of measuring a frequency shift. The direction finding sensor obtains radial velocity information by measuring a frequency shift of a received signal relative to a known frequency.

It should be further noted that the physical composition of the sensor herein may include one or more physical sensors. For example, each physical sensor of the one or more physical sensors may separately measure an azimuth angle, a pitch angle, and a radial velocity, or the azimuth angle, the pitch angle, and the radial velocity may be derived from measurement data of the one or more physical sensors. This is not limited herein.

The sensor can perform measurement on a surrounding target (for example, a target stationary relative to a reference system or a target moving relative to the reference system, an obstacle, or a building), to obtain measurement data of the surrounding target. For example, a radar is used as an example. As shown in FIG. 2, the measurement data may include one or more of a distance r of the target relative to the sensor, an azimuth angle θ of the target relative to the sensor, a pitch angle φ of the target relative to the sensor, a radial velocity \dot{r} of the target relative to the sensor, and a scattering cross section of the target relative to the sensor.

The following further describes exemplary motion state determining methods and exemplary motion state determining apparatuses provided in this application.

FIG. 3 is a schematic flowchart of a motion state determining method according to an embodiment of this application. The method may be performed by a sensor system, a fusion perception system, or a planning/control system integrated with the foregoing systems, such as an assisted driving or autonomous driving system. Alternatively, the method may be performed by software or hardware (for example, a motion state determining apparatus connected wirelessly or by wire to a corresponding sensor or integrated with a corresponding sensor). The following different execution steps may be implemented in a centralized manner or in a distributed manner. As shown in FIG. 3, the motion state determining method includes the following step 301 and step 302.

301: Determine a weight of a grid cell in a velocity grid W₁ based on measurement data from a sensor.

In step 301, the measurement data from the sensor includes a velocity measurement value, where the velocity measurement value may be a radial velocity measurement value, for example, a radial velocity \dot{r} of a surrounding object or target relative to the sensor. Optionally, the measurement data may further include an angle measurement value, for example, an azimuth angle θ and/or a pitch angle φ of the target relative to the sensor. Optionally, the measurement data from the sensor may further include one or more of a distance r of the target relative to the sensor and a scattering cross section of the target relative to the sensor. In addition, the measurement data from the sensor may further include a direction cosine value of the surrounding object or target relative to the sensor. The measurement value may also be information obtained after original measurement data from the sensor is transformed. For example, the direction cosine value may be obtained from the azimuth angle and/or the pitch angle of the target relative to the sensor, or may be obtained from a Cartesian coordinate position and the distance of the target. Specifically, a correspondence between a direction cosine and an azimuth angle and/or a pitch angle is as follows:

For a two-dimensional velocity vector:

Λₓ=cosθ, and Λ_{y}=sinθ, where

Λₓ, Λ_{y} are direction cosines, and θ is the azimuth angle.

For a three-dimensional velocity vector:

Λₓ=cosφcosθ, Λ_{y}=cosφsinθ, and Λ_{z}=sinφ, where

Λₓ, Λ_{y} and Λ_{z} are direction cosines, θ is the azimuth angle, and φ is the pitch angle. In a formula or calculation manner described below, the direction cosine and the azimuth angle and/or the pitch angle may be interchanged according to the foregoing correspondence.

Alternatively, the measurement data in step 301 may be other data obtained through measurement by the sensor. This is not limited in this embodiment of this application.

The measurement data from the sensor may be one frame of measurement data from the sensor. When a radar or sonar sensor is used as an example, the sensor may transmit a signal periodically or aperiodically and obtain measurement data from a received echo signal. For example, the signal transmitted may be a linear frequency modulation signal. Distance information of the target may be obtained based on a delay of the echo signal. The radial velocity measurement value of the target relative to the sensor may be obtained based on phase differences between a plurality of echo signals. The angle measurement value of the target relative to the sensor may be obtained based on a plurality of transmit and/or receive antenna array geometries of the sensor. In addition, the sensor may also be a passive sensor, and passively receives a signal within a period of time to obtain the angle measurement value of the target relative to the sensor. In addition, an offset of a frequency of a received signal relative to a reference frequency may also be measured to obtain the radial velocity measurement value of the target. It may be understood that, due to a diversity of objects or targets in an ambient environment, the sensor may obtain a plurality of pieces of measurement data within a field of view of the sensor for subsequent use. The sensor may perform periodic measurement on the surrounding target with a fixed time length as a cycle, or may perform triggered measurement on a specified area based on a specified time window. Regardless of the periodic measurement or the triggered measurement, the sensor may obtain one or more frames of measurement data. Each frame of measurement data may include a plurality of pieces of measurement data, and each frame of measurement data may be considered as a “snapshot” of the objects or the targets in the ambient environment taken by the sensor.

The velocity grid W₁ includes a plurality of grid cells, each grid cell in the plurality of grid cells corresponds to one velocity vector, and each velocity vector includes at least one velocity component.

Optionally, the velocity vector corresponding to each grid cell may be determined based on an index of the grid cell in each dimension and a resolution cell size in each dimension.

The velocity grid W₁ may be a one-dimensional grid. In this case, the velocity vector corresponding to the grid cell includes one velocity component. For example, as shown in FIG. 4, the velocity grid W₁ is a one-dimensional grid including five grid cells. Each grid cell corresponds to one velocity vector, and the velocity vector includes one x-axis velocity component vₓ. Alternatively, the velocity vector includes one y-axis velocity component v_{y}, or the velocity vector includes one z-axis velocity component v_{z}. As an example, the velocity vector in the velocity grid W₁ shown in FIG. 4 includes the velocity component vₓ.

Each grid cell may be represented by an index i. A velocity vector corresponding to a grid cell i is vₓ(i). A resolution cell size of the one-dimensional velocity grid W₁ shown in FIG. 4 may be equal to an absolute value of a difference between velocity vectors corresponding to two adjacent grid cells, or a step length of a grid cell in the velocity grid W₁. For example, the resolution cell size of the velocity grid W₁ is 0.5 m/s (meters per second), and the velocity vector corresponding to the grid cell i vₓ(i)=0.5·i m/s. It should be noted that a value range and a start value of the index may be flexibly set based on a requirement, and details are not described herein.

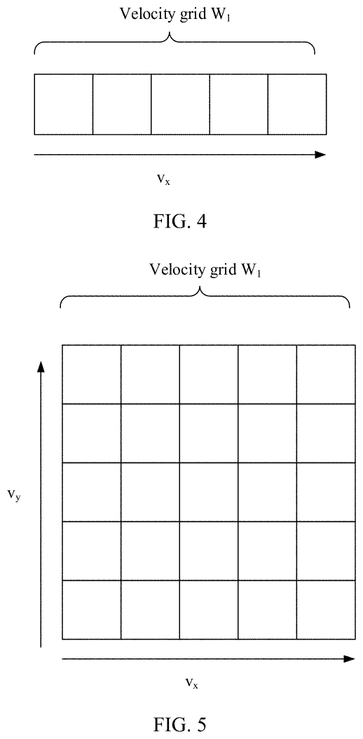

The velocity grid W₁ may be a two-dimensional grid. In this case, the velocity vector corresponding to the grid cell includes two velocity components. For example, as shown in FIG. 5, the velocity grid W₁ includes 25 grid cells. Each grid cell corresponds to one velocity vector, and the velocity vector includes an x-axis velocity component vₓ and a y-axis velocity component v_{y}. Alternatively, the velocity vector includes a y-axis velocity component v_{y} and a z-axis velocity component v_{z}, or the velocity vector includes an x-axis velocity component vₓ and a z-axis velocity component v_{z}. As an example, the velocity vector in the velocity grid W₁ shown in FIG. 5 includes the velocity component vₓ and the velocity component v_{y}. As shown in FIG. 5, the velocity grid W₁ is a two-dimensional grid, including two dimensions vₓ, and v_{y}. The velocity grid W₁ includes five grid cells in the vₓ dimension, where i=0, 1, . . . , 4; and includes five grid cells in the v_{y} dimension, where j=0, 1, . . . , 4. Therefore, the velocity grid W₁ includes 25 grid cells in total.

Each grid cell may be represented by an index (i, j). For example, an index value i=0, 1, . . . , Nᵥₓ-1, and j=0, 1, . . . , N_{vy}-1. N is a resolution cell quantity of the velocity grid W₁ in the vₓ dimension; and N_{vy} is a resolution cell quantity of the velocity grid W₁ in the v_{y} dimension, where Nᵥₓ and N_{vy} are positive integers. A velocity vector corresponding to a grid cell (i, j) is [vₓ (i) v_{y} (j)]^{T}, where []^{T} represents transposition of a matrix or vector. A resolution cell size of the velocity grid W₁ is v_{y,res} in the vₓ dimension, and a resolution cell size of the velocity grid W₁ is v_{y,res} in the v_{y} dimension, where v_{y,res} and v_{y,res} may be the same or may be different. Obviously, v_{y,res} may be equal to an absolute value of a difference between velocity components vₓ corresponding to two adjacent grid cells of the velocity grid W₁ in the vₓ dimension, or a step length of the velocity grid W₁ in the vₓ dimension. v_{y,res} may be equal to an absolute value of a difference between velocity components v_{y} corresponding to two adjacent grid cells of the velocity grid W₁ in the v_{y} dimension, or a step length of the velocity grid W₁ in the v_{y} dimension. For example, that v_{y,res} and v_{y,res} are 0.5 m/s and 0.25 m/s respectively is used as an example. The velocity vector corresponding to the grid cell (i, j) is [vₓ(i) v_{y}(j)]^{T}, namely [0.5·i 0.25·j]^{T}. Other resolution cell sizes apply in a same manner. It should be noted that a value range and a start value of the index and a resolution cell size in each dimension may be flexibly set based on a requirement, and details are not described herein.

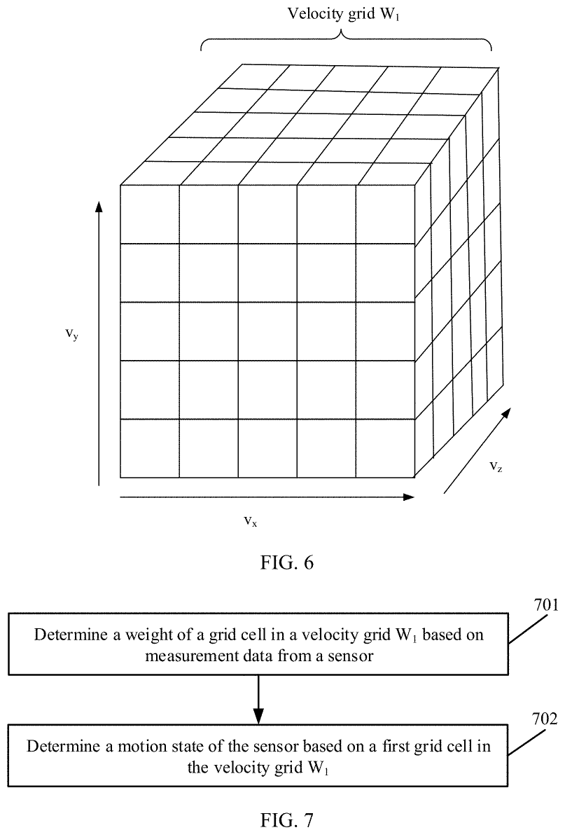

The velocity grid W₁ may be a three-dimensional grid. In this case, the velocity vector corresponding to the grid cell includes three velocity components. For example, as shown in FIG. 6, the velocity grid W₁ includes 125 grid cells. Each grid cell corresponds to one velocity vector, and the velocity vector includes an x-axis velocity component vₓ, a y-axis velocity component v_{y}, and a z-axis velocity component v_{z}. As shown in FIG. 6, the velocity grid W₁ is a three-dimensional grid, including three dimensions vₓ, v_{y}, and v_{z}. The velocity grid W₁ includes five grid cells in the vₓ dimension, where i=0, 1, . . . , 4; includes five grid cells in the v_{y} dimension, where j=0, 1, . . . , 4; and includes five grid cells in the v_{z} dimension, where k=0, 1, . . . , 4. Therefore, the velocity grid W₁ includes 125 grid cells in total.

Each grid cell may be represented by an index (i, j, k). For example, an index value i=0, 1, . . . , Nᵥₓ-1, j=0, 1, . . . , N_{vy}-1, and k=0, 1, . . . , N_{xz}-1. Nᵥₓ is a resolution cell quantity of the velocity grid W₁ in the vₓ dimension; N_{vy} is a resolution cell quantity of the velocity grid W₁ in the v_{y} dimension; and N_{vz} is a resolution cell quantity of the velocity grid W₁ in the v_{z} dimension, where Nᵥₓ, N_{vy}, and N_{vz} are positive integers. A velocity vector corresponding to a grid cell (i, j, k) is [vₓ(i) v_{y}(j) v_{z}(k)]^{T} where []^{T} represents transposition of a matrix or vector. A resolution cell size of the velocity grid W₁ is v_{x,res} in the vₓ dimension, a resolution cell size of the velocity grid W₁ is v_{y,res} in the v_{y} dimension, and a resolution cell size of the velocity grid W₁ is v_{z,res} in the v_{z} dimension, where v_{x,res}, v_{y,yes} and v_{z,res} may be the same or may be different. v_{x,res} may be equal to an absolute value of a difference between velocity components vₓ corresponding to two adjacent grid cells of the velocity grid W₁ in the vₓ dimension, or a step length of the velocity grid W₁ in the vₓ dimension. v_{y,res} may be equal to an absolute value of a difference between velocity components v_{y} corresponding to two adjacent grid cells of the velocity grid W₁ in the v_{y} dimension, or a step length of the velocity grid W₁ in the v_{y} dimension. v_{z,res} may be equal to an absolute value of a difference between velocity components v_{z} corresponding to two adjacent grid cells of the velocity grid W₁ in the v_{z} dimension, or a step length of the velocity grid W₁ in the v_{z} dimension. For example, that v_{x,res} v_{y,res} and v_{z,res} are 0.5 m/s, 1.0 m/s, and 2.5 m/s respectively is used as an example. The velocity vector corresponding to the grid cell (i, j, k) is [vₓ (i) v_{y}(j) v_{z} (k)]^{T}=[0.5·i 1.0·j 2.5·k]^{T}. Resolution cell sizes of other grid cells apply in a same manner. It should be noted that a value range and a start value of the index and a resolution cell size in each dimension may be flexibly set based on a requirement, and details are not described herein.

The velocity grid W₁ may be used to determine a velocity vector of the sensor, where a grid cell in the velocity grid W₁ corresponds to a candidate velocity vector of the sensor; or the velocity grid W₁ may be used to determine a sensor-measured velocity of a target, where a grid cell in the velocity grid W₁ corresponds to a candidate velocity vector of the target. The sensor-measured target may be a target stationary relative to a reference system. For example, a vehicle or unmanned aerial vehicle sensor is used as an example. The reference system may be a geodetic coordinate system, or an inertial coordinate system moving uniformly relative to the earth, and the target may be an object in an ambient environment, such as a guardrail, a curb, a lamp pole, or a building. When a ship-borne sensor is used as an example, the target may be a water surface buoy, a lighthouse, a shoreline, or an island building. When a satellite-borne sensor is used as an example, the target reference object may be a reference object that is stationary or moving at a constant speed relative to a fixed star or a satellite, such as a spaceship.

In an optional implementation, the velocity grid W₁ is determined based on at least one of a resolution cell size of the grid and a reference velocity vector. Specifically, the velocity grid W₁ is determined based on at least one of the reference velocity vector and a resolution cell size of the velocity grid W₁ in each dimension direction. The reference velocity vector may be a velocity vector obtained from another apparatus or another sensor. For example, the reference velocity vector may be a velocity vector of the sensor obtained by using an IMU, or the reference velocity vector is obtained by using a controller area network (CAN) bus of a vehicle in which the sensor is located. The reference velocity vector may alternatively be a preset velocity vector initial value of the sensor or the target. For example, the velocity vector initial value may be a velocity vector value determined by using an initially set parameter such as the resolution cell size according to the method provided in the present invention.

Optionally, the velocity grid W₁ may be determined based on at least one of the resolution cell size and the reference velocity vector, and based on at least one of a resolution cell quantity, a minimum velocity of a velocity component, and a velocity range of the velocity component. Specifically, the velocity grid W₁ is determined based on at least one of the reference velocity vector and the resolution cell size of the velocity grid W₁ in each dimension direction, and at least one of a resolution cell quantity of the velocity grid W₁ in each dimension, a minimum velocity of each velocity component of the velocity grid W₁, and a velocity range of the velocity component of the velocity grid W₁.

That is, the velocity grid W₁ may also be determined before step 301 is performed. The following separately describes in detail three specific manners of determining the velocity grid W₁.

Manner 1: The velocity grid W₁ is determined based on the reference velocity vector and the resolution cell size and quantity of the velocity grid W₁ in each dimension.

The reference velocity vector may be obtained from another sensor, such as an IMU, or another device, such as a device of a platform on which the sensor is located, such as a CAN bus of a vehicle in which the sensor is located. The reference velocity vector may alternatively be a preset velocity vector initial value of the sensor or the target. For example, the velocity vector initial value may be a velocity vector value determined by using an initially set parameter such as the resolution cell size according to the method provided in the present invention.

The resolution cell size and quantity of the velocity grid W₁ in each dimension may be preset or set according to a predefined rule, may be input by a user, or may be set by default.

The reference velocity vector is equal to a velocity vector corresponding to a grid cell at a specified position in the velocity grid W₁ or is between velocity vectors corresponding to two or more grid cells at specified positions. For example, the reference velocity vector is equal to a velocity vector corresponding to a grid cell located at a central position or near a central position of the velocity grid W₁, or the reference velocity vector is between velocity vectors corresponding to two or more grid cells around a central position of the velocity grid W₁.

As an example, the velocity grid W₁ is a two-dimensional grid. The velocity vector corresponding to the grid cell includes two velocity components vₓ and v_{y}. Two components of the reference velocity vector are v_{x,ref} and v_{y,ref}. The reference velocity vector is equal to a velocity vector corresponding to a grid cell whose position is (i₀, j₀) in the velocity grid. The velocity components corresponding to each grid cell (i, j) in the velocity grid W₁ are respectively:

vₓ(i)=v_{x,ref}+(i−i₀)·v_{x,res}, where i=0, 1, . . . , and Nᵥₓ−1 (1); and

v_{y}(j)=v_{y,ref}+·(j−j₀)·v_{y,res}, where j=0, 1, . . . , and N_{vy}−1 (2),

where v_{x,res} and v_{y,res} are resolution cell sizes of the velocity grid W₁ in a vₓ dimension and a v_{y} dimension respectively. Nᵥₓ and N_{vy} are resolution cell quantities of the velocity grid W₁ in the vₓ dimension and the v_{y} dimension respectively.

Optionally, the reference velocity vector may be equal to the velocity vector corresponding to the grid cell (i₀, j₀), where i₀ may be 0, 1, . . . , Nᵥₓ−1, and j₀ may be 0, 1, . . . , N_{vy}−1. Preferably, the grid cell (i₀, j₀) is located at or near a central position of the velocity grid. For example, i₀ may be Nᵥₓ/2, Nᵥₓ/2−1, or Nᵥₓ/2+1, and j₀ may be N_{vy}/2, N_{vy}/2−1, or N_{vy}/2+1.

The resolution cell sizes of the velocity grid W₁ in the vₓ dimension and the v_{y} dimension are respectively v_{x,res}=2.5 m/s, and v_{y,res}=0.5 m/s. The resolution cell quantities of the velocity grid W₁ in the vₓ dimension and the v_{y} dimension are both 25. Therefore, a central grid cell in the velocity grid W₁ is a grid cell (12, 12). Assuming that the reference velocity vector is [10 2]^{T}, a velocity vector corresponding to the grid cell (12, 12) is [10 10]^{T}. The velocity components corresponding to the grid cell (i, j) are respectively:

vₓ(i)=10+(i−12)·2.5=−20+i·2.5, where i=0, 1, . . . , 24; and

v_{y}(j=2+(j−12)·0.5=−4+j·0.5, where j=0, 1, . . . , 24.

Velocity vectors corresponding to all other grid cells can be determined based on the same principle.

That the velocity grid W₁ is a three-dimensional grid is used as an example. Velocity components corresponding to each grid cell (i, j, k) in the velocity grid may be respectively:

vₓ(i)=v_{x,ref}+(i−i₀)·v_{x,res}, where i=0, 1, . . . , Nᵥₓ−1 (3);

v_{y}(j)=v_{y,ref}+(j−j₀)·v_{y,res}, where j=0, 1, . . . , N_{vy}−1 (4); and

v_{z}(k)=v_{z,ref}+(k−k₀)·v_{z,res}, where k=0, 1, . . . , N_{vz}−1 (5),

where v_{x,res}, v_{y,res}, and v_{z,res} are resolution cell sizes of the velocity grid W₁ in a vₓ dimension, a v_{y} dimension, and a v_{z} dimension respectively. Nᵥₓ, N_{vy}, and N_{vz} are resolution cell quantities of the velocity grid W₁ in the vₓ dimension, the v_{y} dimension, and the v_{z} dimension respectively. The reference velocity vector [v_{x,ref}v_{y,ref} v_{z,ref}]^{T} is equal to a velocity vector corresponding to a grid cell (i₀, j₀, k₀), where i₀ may be 0, 1, . . . , Nᵥₓ−1, j₀ may be 0, 1, . . . , N_{vy}−1, and k₀ may be 0, 1, . . . , N_{vz}−1. Preferably, the grid cell (i₀, j₀, k₀) is located at or near a central position of the velocity grid. For example, i₀ may be Nᵥₓ/2, Nᵥₓ/2−1, or Nᵥₓ/2+1, j₀ may be N_{vy}/₂, N_{vy}/2−1, or N_{vy}/2+1, and k₀ may be N_{vz}/2, N_{vz}/2−1, or N_{vz}/2+1.

Similarly, one-dimensional and three-dimensional velocity grids W₁ may be determined by using a method similar to the foregoing method, and details are not described herein.

Manner 2: The velocity grid W₁ is determined based on a minimum value of each velocity component of the velocity grid W₁, and the resolution cell size and quantity of the velocity grid W₁ in each dimension.

The minimum value of the velocity component of the velocity grid W₁, and the resolution cell size and quantity of the velocity grid W₁ in each dimension may be input by a user, or may be set by default.

That the velocity grid W₁ is a two-dimensional grid is used as an example. A velocity vector corresponding to each grid cell (i, j) includes two velocity components, where vₓ(i)=v_{x,min}+i·v_{z,res}, and i=0, 1, . . . , Nᵥₓ−1; and v_{y}(j)=v_{y,min}+j·v_{y,res}, and j=0, 1, . . . , N_{vy}−1. v_{x,min} and v_{y,min} are minimum values of the velocity component vₓ and the velocity component v_{y} of the velocity grid W₁ respectively. Nᵥₓ and N_{vy} are resolution cell quantities of the velocity grid W₁ in a vₓ dimension and a v_{y} dimension respectively. v_{x,res} and v_{y,res} are resolution cell sizes of the velocity grid W₁ in the vₓ dimension and the v_{y} dimension respectively.

An example in which v_{x,min}=−20 m/s, v_{y,min}=−10 m/s, v_{x,res}=0.25 m/s, and v_{y,res}=0.5 m/s is used. As shown in FIG. 5, when Nᵥₓ=40, and Nᵥₓ=20, the velocity vector corresponding to the grid cell (i, j) is [vₓ(i) v_{y}(j)]^{T}=[−20+0.25·i−10+0.5·j]^{T}, where i=0, 1, . . . , Nᵥₓ−1, and j=0, 1, . . . , N_{vy}−1.

Manner 3: The velocity grid W₁ is determined based on a value range of each velocity component of the velocity grid W₁, and the resolution cell size of the velocity grid W₁ in each dimension.

The range of the velocity component of the velocity grid W₁, and the resolution cell size of the velocity grid W₁ in each dimension may be input by a user, or may be set by default. For example, the range of each velocity component of the velocity grid W₁ may be determined based on a range of each component of a velocity vector of a sensor platform; or the range of each velocity component of the velocity grid W₁ may be determined based on a range of each component of a velocity vector of a target measured by the sensor.

In one example, the velocity grid W₁ is a two-dimensional grid. A velocity vector corresponding to each grid cell (i, j) includes two velocity components vₓ and v_{y}. Value ranges of the velocity components are respectively [v_{x,min},v_{y,min}] and [v_{x,max}, v_{y,max}]. Resolution cell sizes of the velocity grid W₁ in a vₓ dimension and a v_{y} dimension are respectively v_{x,res} and v_{y,res}. The velocity vectors corresponding to the grid cell (i, j) are respectively:

vₓ(i)=v_{x,min}+i·v_{x,res}, where i=0, 1, . . . , Nᵥₓ−1 (6); and

v_{y}(j)=v_{y,min}+j·v_{y,res}, where j=0, 1, . . . , N_{vy}−1 (7),

where Nᵥₓ=1+(v_{x,max}−v_{x,min})/v_{x,res}, and N_{vy}=1+(v_{y,max}−v_{y,min})/v_{y,res} are respectively resolution cell quantities of the velocity grid W₁ in the vₓ dimension and the v_{y} dimension.

When a vehicle sensor is used as an example, a velocity range corresponding to vₓ may be [−30, 40] m/s, and a velocity range corresponding to v_{y} is [−10, 10] m/s. The resolution cell sizes in the vₓ dimension and the v_{y} dimension are respectively v_{y}=2 m/s, and v_{y,res}=1 m/s. It can be determined that the resolution cell quantities of the velocity grid W₁ in the vₓ dimension and the v_{y} dimension are respectively Nᵥₓ=36 and Nᵥₓ=21. Therefore, it can be determined that velocity components corresponding to each grid cell in the velocity grid W₁ are respectively vₓ(i)=−20+2·i, where i=0, . . . , 35; and v_{y}(j)=−10+1·i, where j=0, . . . , 20.

In an embodiment of this application, the weight of the grid cell in the velocity grid W₁ is determined based on the measurement data from the sensor.

Specifically, for a piece of measurement data from the sensor, a weighted increment may be determined for each grid cell in the velocity grid W₁, and a weight of the grid cell in the velocity grid W₁ is determined by accumulating weighted increments corresponding to one or more pieces of measurement data from the sensor. In this case, the weight of the grid cell is obtained in a cumulative sum form.

For example, in a two-dimensional velocity grid, a weight of a grid cell (i, j) in the velocity grid W₁ may be expressed as:

w(i,j)=Σₙ₌₁^{N}^{ₘ}wₙ(i,j) (8), where

w (i, j) is the weight of the grid cell (i, j), wₙ(i, j) is a weighted increment that is of the grid cell (i, j) and that is determined based on an n^{th} piece of measurement data, and Nₘ is a quantity of measurement data.

For example, in a three-dimensional velocity grid is used as an example, a weight of a grid cell (i, j, k) in the velocity grid may be expressed as:

w(i, j, k)=Σₙ₌₁^{N}^{ₘ}wₙ(i, j, k) (9), where

w(i, j, k) is the weight of the grid cell (i, j, k), wₙ(i, j, k) is a weighted increment that is of the grid cell (i, j, k) and that is determined based on an n^{th} piece of measurement data, and Nₘ is a quantity of measurement data.

Alternatively, specifically, for one piece of measurement data from the sensor, one weighting factor may be determined for one grid cell in the velocity grid W₁, and a weight of the grid cell in the velocity grid W₁ is determined by multiplying weighting factors corresponding to one or more pieces of measurement data from the sensor. In this case, the weight of the grid cell is obtained in a product form.

For example, a two-dimensional velocity grid is used as an example. A weight of a grid cell (i, j) in the velocity grid may be expressed as:

w(i, j)=Πₙ₌₁^{N}^{ₘ}fₙ(i, j) (10), where

w(i, j) is the weight of the grid cell (i, j), fₙ(i, j) is a weighting factor that is of the grid cell (i, j) and that is determined based on an n^{th} piece of measurement data, and Nₘ is a quantity of measurement data.

For example, a three-dimensional velocity grid is used as an example. A weight of a grid cell (i, j, k) in the velocity grid may be expressed as:

w(i, j, k)=Πₙ₌₁^{N}^{ₘ}fₙ(i, j, k) (11),

where w (i, j, k) is the weight of the grid cell (i, j, k), fₙ(i, j, k) is a weighting factor that is of the grid cell (i, j, k) and that is determined based on an n^{th} piece of measurement data, and Nₘ is a quantity of measurement data.

In this application, the weight of the grid cell may be obtained in the foregoing cumulative sum form or product form.

Specifically, for a piece of measurement data from the sensor, a weighted increment or weighting factor may be determined for each grid cell in the velocity grid W₁. Alternatively, some corresponding grid cells in the velocity grid W₁ may be determined based on a piece of measurement data from the sensor, so that a weighted increment or weighting factor is determined for a corresponding grid cell.

The following describes in detail how to determine some corresponding grid cells in the velocity grid W₁ based on a piece of measurement data from the sensor.

A grid cell that is in the velocity grid W₁ and that corresponds to a piece of measurement data may be determined in the following manner 1.

Manner 1: A second grid cell (i, j) in the velocity grid W₁ is determined based on the n^{th} piece of measurement data, and the second grid cell (i, j) is weighted based on a weighted increment or weighting factor, where a velocity vector corresponding to the second grid cell (i, j) satisfies

|vₓ(i)·cosθₙ+v_{y}(j)·sinθₙ+\dot{r}ₙ|≤T₁ (12),

where θₙ and \dot{r}ₙ, are respectively a measurement value of an azimuth angle and a measurement value of a radial velocity that are included in the n^{th} piece of measurement data, vₓ(i) and v_{y}(j) are respectively an x-axis velocity component and a y-axis velocity component of the velocity vector corresponding to the grid cell (i, j), and T₁ is a non-negative threshold. For example, T₁ may be maximum or minimum values of resolution cell sizes v_{x,res} and v_{y,res}.

If the n^{th} piece of measurement data comes from a target stationary relative to a reference system, a radial velocity \dot{r}ₛ of the sensor relative to the target stationary relative to the reference system and a radial velocity \dot{r}ₙ of the target stationary relative to the reference system relative to the sensor are opposite to each other, that is, \dot{r}ₛ=−\dot{r}ₙ. If the velocity vector of the sensor is [vₓ(i) v_{y}(j)]^{T}, \dot{r}ₛ=vₓ(i)·cosθₙ+v_{y}(j)·sinθₙ−n_{\dot{r}}, where n_{\dot{r}} is an error caused by measurement noise and resolution cell quantization noise. Therefore, if the n^{th} piece of measurement data comes from the target stationary relative to the reference system, the velocity vector corresponding to the grid cell (i, j) that satisfies the inequation (12) is more likely to be the velocity vector of the sensor. Therefore, the grid cell (i, j) that satisfies the foregoing inequation is weighted, and other low-probability grid cells are ignored, to effectively reduce grid cells whose weighted increments or weighting factors need to be calculated, and effectively reduce a calculation amount.

Optionally, in an implementation, for the n^{th} piece of measurement data, the grid cell (i, j) that satisfies the foregoing inequation (12) may be obtained by traversing grid cells in the velocity grid. Specifically, an n^{th} piece of measurement data in one frame of measurement data from the sensor includes at least a measurement value θₙ of an azimuth angle and a measurement value \dot{r}ₙ of a radial velocity. For the grid cell (i, j) in the velocity grid, if the velocity vector [vₓ(i) v_{y}(j)]^{T} corresponding to the grid cell (i, j) satisfies the inequation (12), the weighted increment wₙ,(i, j) or weighting factor fₙ(i, j) corresponding to the grid cell (i, j) is calculated. Otherwise, the weighted increment wₙ(i, j) or weighting factor fₙ(i, j) corresponding to the grid cell (i, j) does not need to be calculated; or equivalently, the weighted increment wₙ,(i, j) corresponding to the grid cell (i, j) is set to 0 or a constant, or the weighting factor fₙ(i, j) is set to 1 or a constant.

Optionally, in another implementation, for the n^{th} piece of measurement data, resolution cells of one dimension in the velocity grid may be traversed, and resolution cells of another dimension may be determined by using the foregoing inequation (12), to obtain the grid cell that satisfies the foregoing inequation (12) and calculate the weighted increment or weighting factor corresponding to the grid cell.

In one example, resolution cells i in a vₓ dimension may be traversed. For example, i=0, . . . , Nᵥₓ−1. For each resolution cell i, one or more resolution cells j in a v_{y} dimension may be determined, where the resolution cell j satisfies

$$j = ⌈ \frac{{\dot{r}}_{n} - {v}_{x} ( i ) \cdot cos {θ}_{n}}{{v}_{y , res} \cdot sin {θ}_{n}} ⌉ , j = ⌊ \frac{{\dot{r}}_{n} - {v}_{x} ( i ) \cdot cos {θ}_{n}}{{v}_{y , res} \cdot sin {θ}_{n}} ⌋ , or j = round ( \frac{{\dot{r}}_{n} - {v}_{x} ( i ) \cdot cos {θ}_{n}}{{v}_{y , res} \cdot sin {θ}_{n}} ) . \qquad ( 13 )$$

Therefore, the grid cell (i, j) corresponding to the n^{th} piece of measurement data is determined.

Alternatively, resolution cells j in a v_{y} dimension may be traversed. For example, j=0, . . . , Nᵥⱼ−1. For each resolution cell j, one or more resolution cells i in a vₓ dimension may be determined, where the resolution cell i satisfies

$$i = ⌈ \frac{{\dot{r}}_{n} - {v}_{y} ( j ) \cdot sin {θ}_{n}}{{v}_{x , res} \cdot cos {θ}_{n}} ⌉ , i = ⌊ \frac{{\dot{r}}_{n} - {v}_{y} ( j ) \cdot sin {θ}_{n}}{{v}_{x , res} \cdot cos {θ}_{n}} ⌋ , or i = round ( \frac{{\dot{r}}_{n} - {v}_{y} ( j ) \cdot sin {θ}_{n}}{{v}_{x , res} \cdot cos {θ}_{n}} ) . \qquad ( 14 )$$

Therefore, the grid cell (i, j) corresponding to the n^{th} piece of measurement data is determined.

Alternatively, when |sinθₙ|≥|cosθₙ|, the resolution cells i in the vₓ dimension are traversed, and one or more resolution cells j in the v_{y} dimension are determined according to (13), to determine the grid cell (i, j) corresponding to the n^{th} piece of measurement data; or when |sinθₙ|≤|cosθₙ|, the resolution cells j in the v_{y} dimension are traversed, and one or more resolution cells i in the vₓ dimension are determined according to (14), to determine the grid cell (i, j) corresponding to the n^{th} piece of measurement data.

In the foregoing formula (13) or (14), [x] indicates a rounding up operation, that is, taking a minimum integer not less than x; [x] indicates a rounding down operation, that is, taking a maximum integer not greater than x; and round(x) indicates a rounding off operation, that is, rounding off a decimal part of x to get an integer.

For example, as shown in FIG. 5, the velocity grid W₁ includes a total of 25 grid cells: a grid cell (0, 0) to a grid cell (4, 4). The grid cells (i, j) may be checked one by one, where i=0, 1, . . . , 4, and j=0, 1, . . . , 4. If the velocity vectors vₓ(i) and v_{y}(j) corresponding to the grid cell (i, j) satisfy the inequation (12), a weighted increment or weighting factor corresponding to the grid cell (i, j) may be calculated. For another example, resolution cells i in the vₓ dimension may be checked one by one, where i=0, 1, . . . , 4; and one or more resolution cells j in the v_{y} dimension may be determined according to (13), to determine the grid cell (i, j) and calculate a weighted increment or weighting factor corresponding to the grid cell (i, j). For another example, resolution cells j in the v_{y} dimension may be checked one by one, where j=0, 1, . . . , 4; and one or more resolution cells i in the vₓ dimension may be determined according to (14), to determine the grid cell (i, j) and calculate a weighted increment or weighting factor corresponding to the grid cell (i, j). Alternatively, if |sinθₙ|≥|cosθₙ|, resolution cells i in the vₓ dimension may be checked one by one, where i=0, 1, . . . , 4; and one or more resolution cells j in the v_{y} dimension may be determined according to (13). Otherwise, resolution cells j in the v_{y} dimension may be checked one by one, where j=0, 1, . . . , 4; and one or more resolution cells i in the vₓ dimension may be determined according to (14), to determine the grid cell (i, j) and calculate a weighted increment or weighting factor corresponding to the grid cell (i, j).

Similarly, for a given n^{th} piece of measurement data, for example, including a measurement value of an azimuth angle, a measurement value of a pitch angle, and a measurement value of a radial velocity, a grid cell (i, j, k) that is in a three-dimensional velocity grid and that corresponds to the n^{th} piece of measurement data can be obtained. Details are not described herein.

For the grid cell (i, j) in the velocity grid, if the velocity vector [vₓ(i) v_{y}(j)]^{T} corresponding to the grid cell (i, j) satisfies the inequation (12), (13), or (14), the weighted increment wₙ(i, j) or weighting factor fₙ(i, j) corresponding to the grid cell (i, j) is calculated. Otherwise, the weighted increment wₙ,(i, j) or weighting factor fₙ(i, j) corresponding to the grid cell (i, j) does not need to be calculated; or equivalently, the weighted increment wₙ(i, j) corresponding to the grid cell (i, j) is set to 0 or a constant, or the weighting factor fₙ(i, j) is set to 1 or a constant.

The weighted increment or weighting factor of the second grid cell is described below.

It should be noted that following calculation of a weighted increment or weighting factor may be used for the second grid cell, or may be used for any grid cell in the velocity grid for the n^{th} piece of measurement data.

Optionally, the weighted increment or weighting factor of the grid cell (i, j) may be a preset value. For example, the preset value may be 1, 2 or another preconfigured constant value.

Optionally, the weighted increment or weighting factor of the grid cell (i, j) may be determined based on the n^{th} piece of measurement data. In this way, the weighting can be performed more precisely, and thus a motion state, especially the velocity vector, of the sensor, can be obtained more precisely.

Specifically, the weighted increment or weighting factor of the grid cell (i, j) may be an exponential function or a linear or a quadratic function of the n^{th} piece of measurement data. For example, the exponential function may be an exponential probability density function or a normal probability density function. For another example, the linear or quadratic function may be a logarithmic form of an exponential probability density function, or a logarithmic form of a normal probability density function.

For example, for the n^{th} piece of measurement data including measurement values of an azimuth angle and a radial velocity, the weighted increment wₙ,(i, j) of the grid cell (i, j) may be

$$\begin{matrix}{w}_{n} ( i , j ) = {a}_{0} exp ( - \frac{1}{{β}_{0}} \cdot \vert \frac{{v}_{x} ( i ) \cdot cos {θ}_{n} + {v}_{y} ( j ) \cdot sin {θ}_{n} + {\dot{r}}_{n}}{σ} \vert ) , & ( 15 ) \\ {w}_{n} ( i , j ) = {a}_{0} exp ( - \frac{1}{{β}_{0}} \cdot \frac{{\vert {v}_{x} ( i ) \cdot cos {θ}_{n} + {v}_{y} ( j ) \cdot sin {θ}_{n} + {\dot{r}}_{n} \vert}^{2}}{{σ}^{2}} ) , & ( 16 ) \\ {w}_{n} ( i , j ) = ln ( {a}_{0} ) - \frac{1}{{β}_{0}} \cdot \vert \frac{{v}_{x} ( i ) \cdot cos {θ}_{n} + {v}_{y} ( j ) \cdot sin {θ}_{n} + {\dot{r}}_{n}}{σ} \vert , or & ( 17 ) \\ {w}_{n} ( i , j ) = ln ( {a}_{0} ) - \frac{1}{{β}_{0}} \cdot \frac{{\vert {v}_{x} ( i ) \cdot cos {θ}_{n} + {v}_{y} ( j ) \cdot sin {θ}_{n} + {\dot{r}}_{n} \vert}^{2}}{{σ}^{2}} . & ( 18 )\end{matrix}$$

Optionally, for the n^{th} piece of measurement data, the weighting factor fₙ(i, j) of the grid cell (i, j) may be

$$\begin{matrix}{f}_{n} ( i , j ) = {a}_{0} exp ( - \frac{1}{{β}_{0}} \cdot \vert \frac{{v}_{x} ( i ) \cdot cos {θ}_{n} + {v}_{y} ( j ) \cdot sin {θ}_{n} + {\dot{r}}_{n}}{σ} \vert ) , & ( 19 ) \\ {f}_{n} ( i , j ) = {a}_{0} exp ( - \frac{1}{{β}_{0}} \cdot \frac{{\vert {v}_{x} ( i ) \cdot cos {θ}_{n} + {v}_{y} ( j ) \cdot sin {θ}_{n} + {\dot{r}}_{n} \vert}^{2}}{{σ}^{2}} ) . & ( 20 )\end{matrix}$$

For formulas (15) to (20), σ is a standard deviation, and σ may be a preset constant. Alternatively, σ can be obtained based on a measurement error of the radial velocity. For example, σ can be obtained as follows:

σ²=σ²+Δ (21),

where σ_{\dot{r}}² is the measurement error of the radial velocity, and Δ is a compensation item. Δ may be a preset constant. Alternatively, Δ may be determined based on the resolution cell size of the velocity grid W₁. For example, Δ can be obtained according to the following formula:

Δ=[(vₓ(i)+σᵥₓ²)sin²(θₙ)+(v_{y}²(j)+σ_{vy}²)cos²(θₙ)−vₓ(i)·v_{y}(j)·sin (2θₙ)]·σ_{θ}² (22),

where σ_{θ}² is a variance of a measurement error of the azimuth angle, and σᵥₓ² and σ_{vy}² are variances of quantization errors of the velocity grid in dimensions Vₓ and V_{y}. For example, σᵥₓ² and σ_{vy}² may be respectively σᵥₓ²=1/12v_{x,res}², σ_{vy}²=1/12v_{y,res}².

v_{x,res} and v_{y,res} are the resolution cell sizes of the velocity grid W₁ in the vₓ dimension and the v_{y} dimension respectively. α₀ and β₀ are configuration parameters. For example,

$${a}_{0} = \frac{1}{\sqrt{2 π} \cdot σ} ,$$

and β₀=2.

Optionally, the weighted increment or weighting factor of the grid cell (i, j) may be determined based on the n^{th} piece of measurement data and a distribution of a scattering section corresponding to a preset target type, where the n^{th} piece of measurement data includes a measurement value of the scattering section.

Optionally, the distribution of the scattering section corresponding to the preset target type may be determined based on an average value and a standard deviation.

The scattering section may be a radar cross-section (RCS). Alternatively, the scattering section may be a scattering section of a sonar or ultrasonic sensor. The distribution of the scattering section corresponding to the preset target type may be determined by collecting measurement values of various targets in various scenarios. For example, the distribution of the scattering section corresponding to the preset target type may be obtained based on measurement data of targets involved in traffic, such as a guardrail, a curb, a lamp pole and a nearby building, and a target moving relative to a reference system, such as a vehicle and a pedestrian.

In this way, in addition to using a velocity and an angle measurement value of the target, a scattering cross section feature of the target can be used, so that the weighting can be performed more precisely by using a feature difference of the target, and thus the motion state, especially the velocity vector, of the sensor, can be obtained more precisely.

Specifically, a scattering cross section feature item included in the weighted increment or weighting factor of the grid cell (i, j) may be an exponential function or a linear or a quadratic function of the measurement value of the scattering cross section in the n^{th} piece of measurement data. For example, the exponential function may be an exponential probability density function or a normal probability density function. For another example, the linear or quadratic function may be a logarithmic form of an exponential probability density function, or a logarithmic form of a normal probability density function.

For example, for the n^{th} piece of measurement data, the weighted increment wₙ(i, j) of the grid cell (i, j) may be

$$\begin{matrix} {w}_{n} ( i , j ) = {w}_{n}^{′} ( i , j ) \cdot {\sum }_{c} [ {a}_{c} \cdot exp ( - \frac{1}{{β}_{c}} \cdot \vert \frac{C {S}_{n} - \overline{CS} ( c )}{{σ}_{CS ( c )}} \vert ) ] , & ( 23 ) \\ {w}_{n} ( i , j ) = {w}_{n}^{′} ( i , j ) \cdot {\sum }_{c} [ {a}_{c} \cdot exp ( - \frac{1}{{β}_{c}} \cdot \frac{{\vert {CS}_{n} - \overline{CS} ( c ) \vert}^{2}}{{σ}_{CS ( c )}^{2}} ) ] , \\ & ( 24 ) \\ {w}_{n} ( i , j ) = ln {w}_{n}^{′} ( i , j ) + ln {\sum }_{c} [ {a}_{c} \cdot exp ( - \frac{1}{{β}_{c}} \cdot \vert \frac{C {S}_{n} - \overline{CS} ( c )}{{σ}_{CS ( c )}} \vert ) ] , or \\ & ( 25 ) \\ {w}_{n} ( i , j ) = ln {w}_{n}^{′} ( i , j ) + ln {\sum }_{c} [ {a}_{c} \cdot exp ( - \frac{1}{{β}_{c}} \cdot \frac{{\vert {CS}_{n} - \overline{CS} ( c ) \vert}^{2}}{{σ}_{CS ( c )}^{2}} ) ] , & ( 26 )\end{matrix}$$

where wₙ′(i, j) may be a constant. Alternatively, wₙ′(i, j) may be wₙ(i, j) in formula (15) or formula (16).

Optionally, for the n^{th} piece of measurement data, the weighting factor fₙ(i, j) of the grid cell (i, j) may be

$$\begin{matrix}{f}_{n} ( i , j ) = {f}_{n}^{′} ( i , j ) \cdot {\sum }_{c} [ {a}_{c} \cdot exp ( - \frac{1}{{β}_{c}} \cdot \vert \frac{C {S}_{n} - \overline{CS} ( c )}{{σ}_{CS ( c )}} \vert ) ] , or & ( 27 ) \\ {f}_{n} ( i , j ) = {f}_{n}^{′} ( i , j ) \cdot {\sum }_{c} [ {a}_{c} \cdot exp ( - \frac{1}{{β}_{c}} \cdot \frac{{\vert {CS}_{n} - \overline{CS} ( c ) \vert}^{2}}{{σ}_{CS ( c )}^{2}} ) ] , & ( 28 )\end{matrix}$$

where fₙ′(i, j) may be a constant. Alternatively, fₙ′(i, j) may be fₙ(i, j) in formula (19) or formula (20).

For σ, refer to the foregoing description of σ. α₀ and β₀ are configuration parameters. For example,

$${a}_{0} = \frac{1}{\sqrt{2 π} \cdot σ} ,$$

and β₀=2. CSₙ measurement value of the scattering section in the n^{th} piece of measurement data. C̅S̅(c) is an average value of a scattering section corresponding to a preset target type c. σCS(c) is a standard deviation of the scattering section corresponding to the preset target type c. The preset target type c may be a static obstacle, a curb, a guardrail, or the like. For example, for the curb or guardrail, typical values may be C̅S̅(c)=−5.4 dBm² (dBm²), and σ_{CS(c)}=8.2 dBm². α_{c} and β_{c} are configuration parameters. For example,

$${a}_{c} = \frac{1}{\sqrt{2 π} \cdot {σ}_{CS ( c )}} ,$$

and β_{c}=2.

That the velocity grid W₁ is a three-dimensional grid is used as an example. In this case, a velocity vector corresponding to a grid cell includes three velocity components. A grid cell that is in the velocity grid W₁ and that corresponds to one piece of measurement data and a corresponding weight may be determined in the following manner 2.

Manner 2: A second grid cell (i, j, k) in the velocity grid W₁ is determined based on the n^{th} piece of measurement data, and the second grid cell (i, j, k) is weighted based on a weighted increment or weighting factor, where a velocity vector corresponding to the second grid cell (i, j, k) satisfies

|vₓ(i)cosφₙcosθₙ+v_{y}(j)cosφₙsinθₙ+v_{z}(k)sinφₙ+\dot{r}ₙ|≤T₂ (29),

where θₙ, φₙ and \dot{r}ₙ are respectively a measurement value of an azimuth angle, a measurement value of a pitch angle, and a measurement value of a radial velocity that are included in the n^{th} piece of measurement data, vₓ(i), v_{y} (j) and v_{z} (k) are respectively an x-axis velocity component, a y-axis velocity component, and a z-axis velocity component of the velocity vector corresponding to the second grid cell (i, j, k), and T₂ is a non-negative threshold. For example, T₂ may be maximum or minimum values of resolution cell sizes v_{x,res}, v_{y,res}, and v_{z,res}.

Similar to the above two-dimensional velocity vector or two-dimensional velocity grid, if the n^{th} piece of measurement data comes from a target stationary relative to a reference system, a radial velocity \dot{r}ₛ of the sensor relative to the target stationary relative to the reference system and a radial velocity \dot{r}ₙ of the target stationary relative to the reference system relative to the sensor are opposite to each other, that is, \dot{r}ₛ=−\dot{r}ₙ.Therefore, if the n^{th} piece of measurement data comes from the target stationary relative to the reference system, the velocity vector corresponding to the grid cell (i, j, k) that satisfies the inequation (29) is more likely to be the velocity vector of the sensor. Therefore, the grid cell (i, j, k) that satisfies the foregoing inequation is weighted, and other low-probability grid cells are ignored, to effectively reduce grid cells whose weighted increments or weighting factors need to be calculated, and effectively reduce a calculation amount.

Optionally, in an implementation, for the n^{th} piece of measurement data, the resolution cells of each dimension in the velocity grid may be traversed successively, and the foregoing inequation (29) is used to obtain the grid cell that satisfies the foregoing inequation (29) and calculate the weighted increment or weighting factor corresponding to the grid cell.

Optionally, in another implementation, for the n^{th} piece of measurement data, resolution cells of one dimension in the velocity grid may be traversed, and resolution cells of another one or two dimensions may be determined by using the foregoing inequation (29), to obtain the grid cell that satisfies the foregoing inequation (29) and calculate the weighted increment or weighting factor corresponding to the grid cell. The principle is similar to that of manner 1, and details are not described herein.

For the grid cell (i, j, k) in the velocity grid, if the velocity vector [vₓ(i) v_{y}(j) v_{z}(k)]^{T} corresponding to the grid cell (i, j, k) satisfies the inequation (29) or an inequation similar to (13) or (14), the weighted increment wₙ,(i, j, k) or weighting factor fₙ(i, j, k) corresponding to the grid cell (i, j, k) is calculated. Otherwise, the weighted increment wₙ(i, j, k) or weighting factor fₙ(i, j, k) corresponding to the grid cell (i, j, k) does not need to be calculated; or equivalently, the weighted increment wₙ(i, j, k) corresponding to the grid cell (i, j, k) is set to 0 or a constant, or the weighting factor fₙ(i, j, k) is set to 1 or a constant.

The weighted increment or weighting factor of the grid cell corresponding to the n^{th} piece of measurement data is described below.

It should be noted that following calculation of a weighted increment or weighting factor may be used for the second grid cell, or may be used for any grid cell in the velocity grid for the n^{th} piece of measurement data.

Optionally, the weighted increment or weighting factor of the grid cell (i, j, k) may be a preset value. For example, the preset value may be 1, 2 or another preconfigured constant value.

Optionally, the weighted increment or weighting factor of the grid cell (i, j, k) may be determined based on the n^{th} piece of measurement data. In this way, the weighting can be performed more precisely, and thus a motion state, especially the velocity vector, of the sensor, can be obtained more precisely.

Specifically, the weighted increment or weighting factor of the grid cell (i, j, k) may be an exponential function or a linear or a quadratic function of the n^{th} piece of measurement data. For example, the exponential function may be an exponential probability density function or a normal probability density function; and the linear or quadratic function may be a logarithmic form of an exponential probability density function, a logarithmic form of a normal probability density function, or the like.

For example, for the n^{th} piece of measurement data including measurement values of an azimuth angle, a pitch angle, and a radial velocity, the weighted increment wₙ(i, j, k) of the grid cell (i, j, k) may be

$$\begin{matrix}{w}_{n} ( i , j , k ) = {a}_{0} exp ( - \frac{1}{{β}_{0}} \cdot \vert \frac{{v}_{x} ( i ) \cdot cos {φ}_{n} cos {θ}_{n} + {v}_{y} ( j ) \cdot cos {φ}_{n} sin {θ}_{n} + {v}_{z} ( k ) \cdot sin {φ}_{n} + {\dot{r}}_{n}}{σ} \vert ) , & ( 30 ) \\ {w}_{n} ( i , j , k ) = {a}_{0} exp ( - \frac{1}{{β}_{0}} \cdot \frac{{\vert {v}_{x} ( i ) \cdot cos {φ}_{n} cos {θ}_{n} + {v}_{y} ( j ) \cdot cos {φ}_{n} sin {θ}_{n} + {v}_{z} ( k ) \cdot sin {φ}_{n} + {\dot{r}}_{n} \vert}^{2}}{{σ}^{2}} ) , & ( 31 ) \\ {w}_{n} ( i , j , k ) = ln ( {a}_{0} ) - \frac{1}{{β}_{0}} \cdot \vert \frac{{v}_{x} ( i ) \cdot cos {φ}_{n} cos {θ}_{n} + {v}_{y} ( j ) \cdot cos {φ}_{n} sin {θ}_{n} + {v}_{z} ( k ) \cdot sin {φ}_{n} + {\dot{r}}_{n}}{σ} \vert , or & ( 32 ) \\ {w}_{n} ( i , j , k ) = ln ( {a}_{0} ) - \frac{1}{{β}_{0}} \cdot \frac{{\vert {v}_{x} ( i ) \cdot cos {φ}_{n} cos {θ}_{n} + {v}_{y} ( j ) \cdot cos {φ}_{n} sin {θ}_{n} + {v}_{z} ( k ) \cdot sin {φ}_{n} + {\dot{r}}_{n} \vert}^{2}}{{σ}^{2}} . & ( 33 )\end{matrix}$$

Optionally, for the n^{th} piece of measurement data, the weighting factor fₙ(i, j, k) of the grid cell (i, j, k) may be

$$\begin{matrix}{f}_{n} ( i , j , k ) = {a}_{0} exp ( - \frac{1}{{β}_{0}} \cdot \vert \frac{\begin{matrix}{v}_{x} ( i ) \cdot cos {φ}_{n} cos {θ}_{n} + \\ {v}_{y} ( j ) \cdot cos {φ}_{n} sin {θ}_{n} + {v}_{z} ( k ) \cdot sin {φ}_{n} + {\dot{r}}_{n}\end{matrix}}{σ} \vert ) , \\ or & ( 34 ) \\ {f}_{n} ( i , j , k ) = {a}_{0} exp ( - \frac{1}{{β}_{0}} \cdot \frac{\begin{matrix}\vert {v}_{x} ( i ) \cdot cos {φ}_{n} cos {θ}_{n} + \\ {v}_{y} ( j ) \cdot cos {φ}_{n} sin {θ}_{n} + {v}_{z} ( k ) \cdot sin {φ}_{n} + {\dot{r}}_{n} {\vert}^{2}\end{matrix}}{{σ}^{2}} ) . & ( 35 )\end{matrix}$$

For formulas (30) to (35), σ is a standard deviation, and σ may be a preset constant. Alternatively, σ can be obtained based on a measurement error of the radial velocity. For example, σ can be obtained as follows:

σ²=σ_{\dot{r}}²+Δ (36),

where σ_{\dot{r}}² is the measurement error of the radial velocity, and Δ is a compensation item. Δ may be a preset constant. Alternatively, Δ may be determined based on the resolution cell size of the velocity grid W₁. For example, Δ can be obtained according to the following formula:

Δ=[(vₓ²+σᵥₓ²)sin²(θₙ)+(v_{y}²(j)+σ_{vy}²)cos²(θₙ)−vₓ(i)·v_{y}(j)·sin(2θₙ)]·cos²(φₙ)·σ_{θ}²+[vₕ²·sin²(φₙ)+(v_{z}²)+σ_{vz}²)cos²(φₙ)−vₕ·v_{z}(k)·sin(2θₙ)]·σ_{φ}² (37), and

vₕ=vₓ(i)cosθₙ+v_{y}(j)sinθₙ (38), where

σ_{θ}² and σ₁₀₀ ² are respectively a variance of a measurement error of the azimuth angle and a variance of a measurement error of the pitch angle, and σᵥₓ², σ_{vy}² and σ_{vz}² are variances of quantization errors of the velocity grid in dimensions vₓ, v_{y}, and v_{z} respectively. For example, σᵥₓ², σ_{vy}², and σ_{vz}² may be respectively

σᵥₓ²=1/12v_{x,res}², σ_{vy}²=1/12v_{y,res}, σ_{vz}²=1/12v_{z,res}².

v_{x,res}, v_{y,res}, and v_{z,res} are the resolution cell sizes of the velocity grid W₁ in the vₓ dimension, the v_{y} dimension, and the v_{z} dimension respectively. α₀ and β₀ are configuration parameters. For example,

$${a}_{0} = \frac{1}{\sqrt{2 π} \cdot σ} ,$$

and β₀=2.

Optionally, the weighted increment or weighting factor of the grid cell (i, j, k) may be determined based on the n^{th} piece of measurement data and a distribution of a scattering section corresponding to a preset target type, where the n^{th} piece of measurement data includes a measurement value of the scattering section.

Specifically, the distribution of the scattering section corresponding to the preset target type may be determined based on an average value and a standard deviation. The scattering section may be a scattering cross section of a radar, sonar, or ultrasonic sensor, or a sensor of another type.

In this way, in addition to using a velocity and an angle measurement value of the target, a scattering cross section feature of the target can be used, so that the weighting can be performed more precisely by using a feature difference of the target, and thus the motion state, especially the velocity vector, of the sensor, can be obtained more precisely.

Specifically, a scattering cross section feature item included in the weighted increment or weighting factor of the grid cell (i, j, k) may be an exponential function or a linear or a quadratic function of the measurement value of the scattering cross section in the n^{th} piece of measurement data. For example, the exponential function may be an exponential probability density function or a normal probability density function; and the linear or quadratic function may be a logarithmic form of an exponential probability density function, a logarithmic form of a normal probability density function, or the like.

For example, for the n^{th} piece of measurement data, the weighted increment wₙ(i, j, k) of the grid cell (i, j, k) may be

$$\begin{matrix}{w}_{n} ( i , j , k ) = {w}_{n}^{′} ( i , j , k ) \cdot {\sum }_{c} [ {a}_{c} \cdot exp ( - \frac{1}{{β}_{c}} \cdot \vert \frac{C {S}_{n} - \overline{CS} ( c )}{{σ}_{CS ( c )}} \vert ) ] , & ( 39 ) \\ {w}_{n} ( i , j , k ) = {w}_{n}^{′} ( i , j , k ) \cdot {\sum }_{c} [ {a}_{c} \cdot exp ( - \frac{1}{{β}_{c}} \cdot \frac{\vert C {S}_{n} - \overline{CS} ( c ) {\vert}^{2}}{{σ}_{CS ( c )}^{2}} ) ] , & ( 40 ) \\ {w}_{n} ( i , j , k ) = ln {w}_{n}^{′} ( i , j , k ) + ln {\sum }_{c} [ {a}_{c} \cdot exp ( - \frac{1}{{β}_{c}} \cdot \vert \frac{C {S}_{n} - \overline{CS} ( c )}{{σ}_{CS ( c )}} \vert ) ] , \\ or & ( 41 ) \\ {w}_{n} ( i , j , k ) = ln {w}_{n}^{′} ( i , j , k ) + ln {\sum }_{c} [ {a}_{c} \cdot exp ( - \frac{1}{{β}_{c}} \cdot \frac{\vert C {S}_{n} - \overline{CS} ( c ) {\vert}^{2}}{{σ}_{CS ( c )}^{2}} ) ] , & ( 42 )\end{matrix}$$

where wₙ′(i, j, k) may be a constant. Alternatively, wₙ′(i, j, k) may be wₙ,(i, j, k) in formula (30) or formula (31).

Optionally, for the n^{th} piece of measurement data, the weighting factor fₙ(i, j, k) of the grid cell (i, j, k) may be

$$\begin{matrix}{f}_{n} ( i , j , k ) = {f}_{n}^{′} ( i , j , k ) \cdot {\sum }_{c} [ {a}_{c} \cdot exp ( - \frac{1}{{β}_{c}} \cdot \vert \frac{{CS}_{n} - \overline{CS} ( c )}{{σ}_{CS ( c )}} \vert ) ] , \\ or & ( 43 ) \\ {f}_{n} ( i , j , k ) = {f}_{n}^{′} ( i , j , k ) \cdot {\sum }_{c} [ {a}_{c} \cdot exp ( - \frac{1}{{β}_{c}} \cdot \frac{{\vert {CS}_{n} - \overline{CS} ( c ) \vert}^{2}}{{σ}_{CS ( c )}^{2}} ) ] , & ( 44 )\end{matrix}$$

where fₙ′(i, j, k) may be a constant. Alternatively, fₙ′(i, j, k) may be fₙ(i, j, k) in formula (34) or formula (35).

σ is a standard deviation, and σ may be a preset constant. Alternatively, σ can be obtained based on a measurement error of the radial velocity. α₀ and β₀ are configuration parameters. For example,

$${a}_{0} = \frac{1}{\sqrt{2 π} \cdot σ} ,$$

and β₀=2.CSₙ is the measurement value of the scattering section in the n^{th} piece of measurement data. C̅S̅(c) is an average value of a scattering section corresponding to a preset target type c. σ_{CS(c)} is a standard deviation of the scattering section corresponding to the preset target type c. The preset target type c may be a static obstacle, a curb, a guardrail, or the like. For example, for the curb or guardrail, typical values may be C̅S̅(c)=−5.4 dBm², and σ_{CS(c)}=8.2 dBm². α_{c} and β_{c} are configuration parameters. For example, α_{c}=

$$\frac{1}{\sqrt{2 π} \cdot {σ}_{CS ( c )}} , \qquad$$

and β_{c}=2.

In an example, the velocity grid W₁ is a two-dimensional grid. In this case, a velocity vector corresponding to a grid cell includes two velocity components. A grid cell that is in the velocity grid W₁ and that corresponds to one piece of measurement data and a corresponding weight may be determined in the following manner 3.

Manner 3: A second grid cell (i, j) in the velocity grid W₁ is determined based on the n^{th} piece of measurement data, and the second grid cell (i, j) is weighted based on a weighted increment or weighting factor, where a velocity vector corresponding to the second grid cell (i, j) satisfies

|vₓ(i)cosθₙ+v_{y}(j)sinθₙ−\dot{r}ₙ|≤T₁ (45),

where θₙ and \dot{r}ₙ are respectively a measurement value of an azimuth angle and a measurement value of a radial velocity that are included in the n^{th} piece of measurement data, vₓ(i) and v_{y}(j) are respectively an x-axis component and a y-axis component of the velocity vector corresponding to the second grid cell, and T₁ is a non-negative threshold. For example, T₁ may be maximum or minimum values of resolution cell sizes v_{x,res}, and v_{y,res}.

If the n^{th} piece of measurement data comes from a target stationary relative to a reference system, a radial velocity \dot{r}ₛ of the sensor relative to the target stationary relative to the reference system and a radial velocity \dot{r}ₙ of the target n stationary relative to the reference system relative to the sensor are opposite to each other, that is, \dot{r}ₛ=\dot{r}ₙ. If the velocity vector of the sensor is [vₓ(i) v_{y}(j)]^{T}, \dot{r}ₙ=vₓ(i)·cosθₙ+v_{y}(j)·sinθₙ−n_{\dot{r}}, where n_{\dot{r}}is an error caused by measurement noise and resolution cell quantization noise. Therefore, if the n^{th} piece of measurement data comes from the target stationary relative to the reference system, the velocity vector corresponding to the grid cell (i, j) that satisfies the inequation (45) is more likely to be an opposite number of the velocity vector of the sensor. Therefore, the grid cell (i, j) that satisfies the foregoing inequation is weighted, and other low-probability grid cells are ignored, to effectively reduce grid cells whose weighted increments or weighting factors need to be calculated, and effectively reduce a calculation amount.

A principle of determining the grid cell corresponding to one piece of measurement data in manner 3 is similar to that in manner 1, except that the velocity vector corresponding to the second grid cell (i, j) herein satisfies a different inequation. A method for determining the grid cell corresponding to the n^{th} piece of measurement data is not described herein again by using an example.

For the grid cell (i, j) in the velocity grid, if the velocity vector [vₓ(i) v_{y}(j)]^{T} corresponding to the grid cell (i, j) satisfies the inequation (45), the weighted increment wₙ,(i, j) or weighting factor fₙ(i, j) corresponding to the grid cell (i, j) is calculated. Otherwise, the weighted increment wₙ,(i, j) or weighting factor fₙ(i, j) corresponding to the grid cell (i, j) does not need to be calculated; or equivalently, the weighted increment wₙ(i, j) corresponding to the grid cell (i, j) is set to 0 or a constant, or the weighting factor fₙ(i, j) is set to 1 or a constant.

The weighted increment or weighting factor of the grid cell corresponding to the n^{th} piece of measurement data is described below.

It should be noted that following calculation of a weighted increment or weighting factor may be used for the second grid cell, or may be used for any grid cell in the velocity grid for the n^{th} piece of measurement data.

Optionally, the weighted increment or weighting factor of the grid cell (i, j) may be a preset value. For example, the preset value may be 1, 2 or another preconfigured constant value.

Optionally, the weighted increment or weighting factor of the grid cell (i, j) may be determined based on the n^{th} piece of measurement data. In this way, the weighting can be performed more precisely, and thus a motion state, especially the velocity vector, of the sensor, can be obtained more precisely.

Specifically, the weighted increment or weighting factor of the grid cell (i, j) may be an exponential function or a linear or a quadratic function of the n^{th} piece of measurement data. For example, the exponential function may be an exponential probability density function or a normal probability density function. For another example, the linear or quadratic function may be a logarithmic form of an exponential probability density function, or a logarithmic form of a normal probability density function.

For example, for the n^{th} piece of measurement data including measurement values of an azimuth angle and a radial velocity, the weighted increment wₙ(i, j) of the grid cell (i, j) may be

$$\begin{matrix}{w}_{n} ( i , j ) = {a}_{0} exp ( - \frac{1}{{β}_{0}} \cdot \vert \frac{{v}_{x} ( i ) \cdot cos {θ}_{n} + {v}_{y} ( j ) \cdot sin {θ}_{n} - {\dot{r}}_{n}}{σ} \vert ) , & ( 46 ) \\ {w}_{n} ( i , j ) = {a}_{0} exp ( - \frac{1}{{β}_{0}} \cdot \frac{{\vert {v}_{x} ( i ) \cdot cos {θ}_{n} + {v}_{y} ( j ) \cdot sin {θ}_{n} - {\dot{r}}_{n} \vert}^{2}}{{σ}^{2}} ) , & ( 47 ) \\ {w}_{n} ( i , j ) = ln ( {a}_{0} ) - \frac{1}{{β}_{0}} \cdot \vert \frac{{v}_{x} ( i ) \cdot cos {θ}_{n} + {v}_{y} ( j ) \cdot sin {θ}_{n} - {\dot{r}}_{n}}{σ} \vert , \\ or & ( 48 ) \\ {w}_{n} ( i , j ) = ln ( {a}_{0} ) - \frac{1}{{β}_{0}} \cdot \frac{{\vert {v}_{x} ( i ) \cdot cos {θ}_{n} + {v}_{y} ( j ) \cdot sin {θ}_{n} - {\dot{r}}_{n} \vert}^{2}}{{σ}^{2}} . & ( 49 )\end{matrix}$$

Optionally, for the n^{th} piece of measurement data, the weighting factor fₙ(i, j) of the grid cell (i, j) may be

$$\begin{matrix}{f}_{n} ( i , j ) = {a}_{0} exp ( - \frac{1}{{β}_{0}} \cdot \vert \frac{{v}_{x} ( i ) \cdot cos {θ}_{n} + {v}_{y} ( j ) \cdot sin {θ}_{n} - {\dot{r}}_{n}}{σ} \vert ) , \\ or & ( 50 ) \\ {f}_{n} ( i , j ) = {a}_{0} exp ( - \frac{1}{{β}_{0}} \cdot \frac{{\vert {v}_{x} ( i ) \cdot cos {θ}_{n} + {v}_{y} ( j ) \cdot sin {θ}_{n} - {\dot{r}}_{n} \vert}^{2}}{{σ}^{2}} ) . & ( 51 )\end{matrix}$$

For formulas (46) to (51), σ is a standard deviation, and σ may be a preset constant. Alternatively, σ can be obtained based on a measurement error of the radial velocity. For example, σ can be obtained according to (21). α₀ and β₀ are configuration parameters. For example,

$${a}_{0} = \frac{1}{\sqrt{2 π} \cdot σ} ,$$

and β₀=2.

Optionally, the weighted increment or weighting factor of the grid cell (i, j) may be determined based on the n^{th} piece of measurement data and a distribution of a scattering section corresponding to a preset target type, where the n^{th} piece of measurement data includes a measurement value of the scattering section.

Specifically, the distribution of the scattering section corresponding to the preset target type may be determined based on an average value and a standard deviation.

The scattering section may be a radar cross-section. Alternatively, the scattering section is a scattering section of a sonar or ultrasonic sensor. In this way, in addition to using a velocity and an angle measurement value of the target, a scattering cross section feature of the target can be used, so that the weighting can be performed more precisely by using a feature difference of the target, and thus the motion state, especially the velocity vector, of the sensor, can be obtained more precisely.

For example, for the n^{th} piece of measurement data, the weighted increment wₙ(i, j) of the grid cell (i, j) may be shown in (23), (24), (25), or (26), where wₙ′(i ,j) may be a constant, or may be wₙ(i, j) in formula (46) or formula (47).

Optionally, for the n^{th} piece of measurement data, the weighting factor fₙ(i, j) of the grid cell (i, j) may be shown in (27) or (28), where fₙ′(i, j) may be a constant, for example, fₙ′(i, j) may alternatively be fₙ(i, j) in formula (50) or formula (51).

In an example, the velocity grid W₁ is a three-dimensional grid. In this case, a velocity vector corresponding to a grid cell includes three velocity components. A grid cell that is in the velocity grid W₁ and that corresponds to one piece of measurement data and a corresponding weight may be determined in the following manner 4.

Manner 4: A second grid cell (i, j, k) in the velocity grid W₁ is determined based on the n^{th} piece of measurement data, and the second grid cell (i, j, k) is weighted based on a weighted increment or weighting factor, where a velocity vector corresponding to the second grid cell (i, j, k) satisfies

|vₓ(i)cosφₙcosθₙ+v_{y}(j)cosφₙsinθₙv_{z}(k)sinφₙ−\dot{r}ₙ|≤T₂ (52), where

θₙ, φₙ and \dot{r}ₙ are respectively a measurement value of an azimuth angle, a measurement value of a pitch angle, and a measurement value of a radial velocity that are included in the n^{th} piece of measurement data,

vₓ(i), v_{y}(j) and v_{z}(k) are respectively an x-axis velocity component, a y-axis velocity component, and a z-axis velocity component of the velocity vector corresponding to the second grid cell (i, j, k), and T₂ is a non-negative threshold. For example, T₂ may be maximum or minimum values of resolution cell sizes v_{x,res}, v_{y,res}, and v_{z,res}.

Similar to the above two-dimensional velocity vector or two-dimensional velocity grid, if the n^{th} piece of measurement data comes from a target stationary relative to a reference system, a radial velocity \dot{r}ₛ of the sensor relative to the target stationary relative to the reference system and a radial velocity \dot{r}ₙ of the target stationary relative to the reference system relative to the sensor are opposite to each other, that is, \dot{r}ₛ=\dot{r}ₙ. Therefore, if the n^{th} piece of measurement data comes from the target stationary relative to the reference system, the velocity vector corresponding to the grid cell (i, j, k) that satisfies the inequation (52) is more likely to be an opposite number of the velocity vector of the sensor. Because a quantity of targets stationary relative to the reference system is relatively large in an environment, when a weight of a grid cell is higher, it is more likely that a velocity vector corresponding to the grid cell is a velocity vector of the target stationary relative to the reference system. An opposite number of the velocity vector of the target stationary relative to the reference system is the velocity vector of the sensor. Therefore, the grid cell (i, j) that satisfies the foregoing inequation is weighted, and other low-probability grid cells are ignored, to effectively reduce grid cells whose weighted increments or weighting factors need to be calculated, and effectively reduce a calculation amount.

A principle of the grid cell corresponding to the piece of measurement data in manner 4 is similar to that in manner 2, except that the velocity vector corresponding to the second grid cell (i, j, k) herein satisfies a different relationship. A method for determining the grid cell corresponding to the n^{th} piece of measurement data is not described herein again.

For the grid cell (i, j, k) in the velocity grid, if the velocity vector [vₓ(i) v_{y}(j) v_{z}(k)]_{T} corresponding to the grid cell (i, j, k) satisfies the inequation (52), the weighted increment wₙ(i, j, k) or weighting factor fₙ(i, j, k) corresponding to the grid cell (i, j, k) is calculated. Otherwise, the weighted increment wₙ,(i, j, k) or weighting factor fₙ(i, j, k) corresponding to the grid cell (i, j, k) does not need to be calculated; or equivalently, the weighted increment wₙ,(i, j, k) corresponding to the grid cell (i, j, k) is set to 0 or a constant, or the weighting factor fₙ(i, j, k) is set to 1 or a constant.

The weighted increment or weighting factor of the grid cell corresponding to the n^{th} piece of measurement data is described below.

It should be noted that following calculation of a weighted increment or weighting factor may be used for the second grid cell, or may be used for any grid cell in the velocity grid for the n^{th} piece of measurement data.

Optionally, the weighted increment or weighting factor of the grid cell (i, j, k) may be a preset value. For example, the preset value may be 1, 2 or another preconfigured constant value.

Optionally, the weighted increment or weighting factor of the grid cell (i, j, k) is determined based on the n^{th} piece of measurement data. In this way, the weighting can be performed more precisely, and thus a motion state, especially the velocity vector, of the sensor, can be obtained more precisely.

Specifically, the weighted increment or weighting factor of the grid cell (i, j, k) may be an exponential function or a linear or a quadratic function of the n^{th} piece of measurement data. For example, the exponential function may be an exponential probability density function or a normal probability density function; and the linear or quadratic function may be a logarithmic form of an exponential probability density function, a logarithmic form of a normal probability density function, or the like.

For example, for the n^{th} piece of measurement data including measurement values of an azimuth angle, a pitch angle, and a radial velocity, the weighted increment wₙ(i, j, k) of the grid cell (i, j, k) may be

$$\begin{matrix}{w}_{n} ( i , j , k ) = {a}_{0} exp ( - \frac{1}{{β}_{0}} \cdot \vert \frac{{v}_{x} ( i ) \cdot cos {φ}_{n} cos {θ}_{n} + {v}_{y} ( j ) \cdot cos {φ}_{n} sin {θ}_{n} + {v}_{z} ( k ) \cdot sin {φ}_{n} - {\dot{r}}_{n}}{σ} \vert ) , & ( 53 ) \\ {w}_{n} ( i , j , k ) = {a}_{0} exp ( - \frac{1}{{β}_{0}} \cdot \frac{( {\vert {v}_{x} ( i ) \cdot cos {φ}_{n} cos {θ}_{n} + {v}_{y} ( j ) \cdot cos {φ}_{n} sin {θ}_{n} + {v}_{z} ( k ) \cdot sin {φ}_{n} - {\dot{r}}_{n} \vert}^{2} )}{( {σ}^{2} )} ) , & ( 54 ) \\ {w}_{n} ( i , j , k ) = ln ( {a}_{0} ) - \frac{1}{{β}_{0}} \cdot \vert \frac{{v}_{x} ( i ) \cdot cos {φ}_{n} cos {θ}_{n} + {v}_{y} ( j ) \cdot cos {φ}_{n} sin {θ}_{n} + {v}_{z} ( k ) \cdot sin {φ}_{n} - {\dot{r}}_{n}}{σ} \vert , \\ or & ( 55 ) \\ {w}_{n} ( i , j , k ) = ln ( {a}_{0} ) - \frac{1}{{β}_{0}} \cdot \frac{{\vert {v}_{x} ( i ) \cdot cos {φ}_{n} cos {θ}_{n} + {v}_{y} ( j ) \cdot cos {φ}_{n} sin {θ}_{n} + {v}_{z} ( k ) \cdot sin {φ}_{n} - {\dot{r}}_{n} \vert}^{2}}{( {σ}^{2} )} . & ( 56 )\end{matrix}$$

Optionally, for the n^{th} piece of measurement data, the weighting factor fₙ(i, j, k) of the grid cell (i, j, k) may be

$$\begin{matrix}{f}_{n} ( i , j , k ) = {a}_{0} exp ( - \frac{1}{{β}_{0}} \cdot \vert \frac{{v}_{x} ( i ) \cdot cos {φ}_{n} cos {θ}_{n} + {v}_{y} ( j ) \cdot cos {φ}_{n} sin {θ}_{n} + {v}_{z} ( k ) \cdot sin {φ}_{n} - {\dot{r}}_{n}}{σ} \vert ) , \\ or & ( 57 ) \\ {f}_{n} ( i , j , k ) = {a}_{0} exp ( - \frac{1}{{β}_{0}} \cdot \frac{\begin{matrix}\vert {v}_{x} ( i ) \cdot cos {φ}_{n} cos {θ}_{n} + {v}_{y} ( j ) \cdot \\ {cos {φ}_{n} sin {θ}_{n} + {v}_{z} ( k ) \cdot sin {φ}_{n} - {\dot{r}}_{n} \vert}^{2}\end{matrix}}{( {σ}^{2} )} ) . & ( 58 )\end{matrix}$$

For formulas (53) to (58), σ is a standard deviation, and σ may be a preset constant. Alternatively, σ can be obtained based on a measurement error of the radial velocity. For example, σ can be obtained according to formulas (36) to (38). α₀ and β₀ are configuration parameters. For example,

$${a}_{0} = \frac{1}{\sqrt{2 π} \cdot σ} ,$$

and β₀=2.

Optionally, the weighted increment or weighting factor of the grid cell (i, j, k) may be determined based on the n^{th} piece of measurement data and a distribution of a scattering section corresponding to a preset target type, where the n^{th} piece of measurement data includes a measurement value of the scattering section.

Specifically, the distribution of the scattering section corresponding to the preset target type may be determined based on an average value and a standard deviation. The scattering section may be a scattering cross section of a radar, sonar, or ultrasonic sensor, or a sensor of another type.

In this way, in addition to using a velocity and an angle measurement value of the target, a scattering cross section feature of the target can be used, so that the weighting can be performed more precisely by using a feature difference of the target, and thus the motion state, especially the velocity vector, of the sensor, can be obtained more precisely.

For example, for the n^{th} piece of measurement data, the weighted increment wₙ(i, j, k) of the grid cell (i, j, k) may be shown in (39), (40), (41), or (42), where wₙ′(i, j, k) may be a constant. Alternatively, wₙ′(i, j, k) may be wₙ(i, j, k) in formula (53) or formula (54).

Optionally, for the n^{th} piece of measurement data, the weighting factor fₙ(i, j, k) of the grid cell (i, j, k) may be shown in (43) or (44), where fₙ′(i, j, k) may be a constant. Alternatively, fₙ′(i, j, k) may be fₘ(i, j, k) in formula (57) or formula (58).

302: Determine the motion state of the sensor based on the weight of the grid cell in the velocity grid W₁, where the motion state of the sensor includes the velocity vector of the sensor.

The weight of the grid cell may be a sum of weighted increments of a plurality of pieces of measurement data in the grid cell. For example, a weight of a two-dimensional grid cell is shown in formula (8), and a weight of a three-dimensional grid cell is shown in formula (9). Alternatively, the weight of the grid cell may be a product of weighting factors of a plurality of pieces of measurement data in the grid cell. For example, a weight of a two-dimensional grid cell is shown in formula (10), and a weight of a three-dimensional grid cell is shown in formula (11).

In an embodiment of this application, a dimension of the velocity vector of the sensor and a velocity component included are the same as a dimension and a velocity component that are of a velocity grid or a grid cell. For example, if a velocity vector corresponding to a one-dimensional velocity grid W₁ or grid cell includes a velocity component vₓ the velocity vector of the sensor is one-dimensional and includes the velocity component v_{z}. If a velocity vector corresponding to a two-dimensional velocity grid W₁ or grid cell includes velocity components vₓ and v_{y}, the velocity vector of the sensor is a two-dimensional vector, including the velocity components vₓ and v_{y}. Similarly, for a three-dimensional velocity grid, the velocity vector of the sensor is a three-dimensional vector, including velocity components vₓ, v_{y} and v_{z}.

Optionally, in addition to the velocity vector of the sensor, the motion state of the sensor may further include a position of the sensor. For example, the position of the sensor may be obtained based on the velocity vector and a time interval by using a specified start time point or an initial position as a reference.

Optionally, the determining of the motion state of the sensor based on the weight of the grid cell in the velocity grid W₁ may include: determining a first grid cell based on the weight of the grid cell in the velocity grid W₁, where a velocity vector corresponding to the first grid cell is the velocity vector of the sensor.

Specifically, in this case, the grid cell in the velocity grid W₁ corresponds to a candidate velocity vector of the sensor. The grid cell and the weight of the grid cell may be determined according to one or more combinations of formulas (8) to (11) and (12) to (44).

Optionally, the first grid cell may be a grid cell with a largest weight in the velocity grid W₁; the first grid cell may be a grid cell that is in a neighborhood of a grid cell with a largest weight in the velocity grid W₁ and that is closest to the reference velocity vector; or the first grid cell may be a grid cell that is among a plurality of grid cells with maximum weights in the velocity grid W₁ and that corresponds to a velocity vector closest to the reference velocity vector. The grid cells with maximum weights may be grid cells whose weights are greater than a threshold, or the grid cells with maximum weights may be N grid cells with the largest weight.

For example, as shown in FIG. 4, an example in which the velocity grid includes grid cells 0 to 4 is used. If a weight of the grid cell 3 in the grid cells 0 to 4 is the largest, the first grid cell may be the grid cell 3. Alternatively, if a weight of the grid cell 3 is the largest, the grid cell 2 and the grid cell 4 are in a neighborhood of the grid cell 3, and a velocity vector corresponding to the grid cell 2 is closest to the reference velocity vector, the first grid cell may be the grid cell 2. Alternatively, if weights of the grid cell 2 and the grid cell 3 in the grid cells 0 to 4 are greater than the threshold, and a velocity vector corresponding to the grid cell 2 is closest to the reference velocity vector, the first grid cell may be the grid cell 2. Alternatively, the grid cells with maximum weights may be the N grid cells with the largest weight. For example, the grid cells 0 to 4 are sorted in descending order of weights, to obtain a sorting result as follows: grid cell 4, grid cell 3, grid cell 2, grid cell 1, and grid cell 0. The grid cells with maximum weights are three grid cells with the largest weight. In this case, the grid cell 4, the grid cell 3, and the grid cell 2 are the grid cells with maximum weights. If a velocity vector corresponding to the grid cell 2 is closest to the reference velocity vector, the first grid cell may be the grid cell 2. It is similar when a velocity vector corresponding to a grid cell in the velocity grid W₁ includes a plurality of velocity components, and details are not described herein.

In this embodiment of the present invention, the weight of the grid cell in the velocity grid W₁ is determined based on the measurement data from the sensor, where the measurement data includes at least the velocity measurement value, and the motion state of the sensor is determined based on the weight of grid cell in the velocity grid, where the motion state of the sensor includes at least the velocity vector of the sensor. Because there is relative motion between the sensor and a target measured by the sensor, the measurement data from the sensor may include a measurement value of a velocity of the relative motion. In addition, targets stationary relative to a reference system in the targets measured by the sensor are distributed diversely with a large amount of data, and velocity vectors of the targets stationary relative to the reference system and components of a velocity of the sensor are opposite to each other. Therefore, a weight of a grid cell that is in the velocity grid and that corresponds to the velocity vector of the sensor will be the largest. Therefore, according to the method of the present invention, measurement data corresponding to a plurality of targets stationary relative to the reference system can be effectively used, and the impact of a measurement error or interference can be effectively reduced, so that the manner of determining the motion state has higher precision. In addition, the velocity vector of the sensor can be determined based on single frame data, thereby achieving good real-time results.

Optionally, the determining of the motion state of the sensor based on the weight of the grid cell in the velocity grid may alternatively include: determining a first grid cell based on the weight of the grid cell in the velocity grid, where each velocity component of the velocity vector of the sensor is an opposite number of each velocity component of the velocity vector corresponding to the first grid cell.

Specifically, in this case, the grid cell in the velocity grid corresponds to a candidate velocity vector of a target measured by the sensor. The target measured by the sensor may be a target stationary relative to a reference system, for example, the reference system may be a geodetic coordinate system, or an inertial coordinate system relative to the earth.

The weight of the grid cell may be determined according to one or more combinations of formulas (8) to (11), (23) to (26), and (45) to (58).

Optionally, the first grid cell may be a grid cell with a largest weight in the velocity grid W₁; the first grid cell may be a grid cell that is in a neighborhood of a grid cell with a largest weight in the velocity grid W₁ and that is closest to the reference velocity vector; or the first grid cell may be a grid cell that is among a plurality of grid cells with maximum weights in the velocity grid W₁ and that corresponds to a velocity vector closest to the reference velocity vector. For specific descriptions of the first grid cell in the velocity grid W₁, refer to descriptions in the foregoing method embodiment. Details are not described herein again.

In this embodiment of the present invention, the weight of the grid cell in the velocity grid is determined based on the measurement data from the sensor, where the measurement data includes at least the velocity measurement value, and the motion state of the sensor is determined based on the weight of grid cell in the velocity grid, where the motion state of the sensor includes at least the velocity vector of the sensor. Because there is relative motion between the sensor and the target measured by the sensor, the measurement data from the sensor may include a measurement value of a velocity of the relative motion. In addition, targets stationary relative to the reference system in targets measured by the sensor are distributed diversely with a large amount of data. Therefore, a weight of a grid cell that is in the velocity grid and that corresponds to a velocity vector of the target stationary relative to the reference system will be the largest. Therefore, according to the method of the present invention, measurement data corresponding to a plurality of targets stationary relative to the reference system can be effectively used, impact of a measurement error or interference can be effectively reduced, velocity vectors of the targets stationary relative to the reference system are obtained, and velocity components of the velocity vectors of the targets stationary relative to the reference system and velocity components of a velocity of the sensor are opposite to each other, so that a high-precision motion state of the sensor can be obtained by using this method. In addition, the velocity vector of the sensor can be determined based on single frame data in the method, thereby achieving good real-time results.

The first grid cell may be determined based on weights of all grid cells in the velocity grid, or may be determined based on weights of some grid cells in the velocity grid, for example, grid cells on a diagonal or minor diagonal or back-diagonal or minor back-diagonal line in the velocity grid; or grid cells that are in the velocity grid and that correspond to velocity vectors within a neighborhood of the reference velocity vector. By using the some grid cells, computation of searching can be reduced effectively, while correctness of searching results can be ensured without too much loss.

FIG. 7 is a schematic flowchart of a motion state determining method according to an embodiment of this application. As shown in FIG. 7, the motion state determining method includes the following step 701 and step 702, where step 702 is a specific implementation of step 302.

701: Determine a weight of a grid cell in a velocity grid W₁ based on measurement data from a sensor.

A specific implementation principle of step 701 is the same as that of step 301. For details, refer to the implementation principle of step 301. Details are not described herein.

702: Determine a motion state of the sensor based on a first grid cell in the velocity grid W₁.

The first grid cell in the velocity grid W₁ may be a grid cell with a largest weight in the velocity grid W₁, the first grid cell may be a grid cell that is in a neighborhood of a grid cell with a largest weight in the velocity grid and that is closest to a reference velocity vector, or the first grid cell may be a grid cell that is among a plurality of grid cells with maximum weights in the velocity grid and that corresponds to a velocity vector closest to a reference velocity vector. For specific descriptions of the first grid cell in the velocity grid W₁, refer to descriptions in the foregoing method embodiment. Details are not described herein again.

If a velocity vector corresponding to the grid cell in the velocity grid W₁ is a candidate velocity vector of the sensor, a velocity vector of the first grid cell in the velocity grid W₁ among a plurality of velocity vectors in the velocity grid W₁ is most likely to be a velocity vector of the sensor. Therefore, the velocity vector of the sensor can be accurately determined based on the first grid cell.

If a velocity vector corresponding to the grid cell in the velocity grid W₁ is a candidate velocity vector of a target measured by the sensor, the velocity vector of the first grid cell in the velocity grid W₁ among a plurality of velocity vectors in the velocity grid W₁ is most likely to be a velocity vector of a target stationary relative to a reference system. Each velocity component of the velocity vector of the target stationary relative to the reference system and each velocity component of the velocity vector of the sensor are equal in size but opposite in direction. Therefore, each velocity component of the velocity vector of the sensor is an opposite number of each velocity component of the velocity vector of the target stationary relative to the reference system. Targets stationary relative to the reference system in the targets measured by the sensor are distributed diversely with a large amount of data. Therefore, the velocity vectors of the targets stationary relative to the reference system can be accurately determined based on the first grid cell, so that the velocity vector of the sensor can be accurately determined. Therefore, according to the method described in FIG. 7, the velocity vector of the sensor can be determined accurately.

In an optional implementation, when the velocity grid W₁ has a plurality of grid cells with the largest weight, the first grid cell in the velocity grid W₁ is a grid cell that is among the plurality of grid cells with the largest weight and that corresponds to a largest velocity vector. For example, in the velocity grid W₁ shown in FIG. 5, if weights of a grid cell (3, 3) and a grid cell (4, 4) are the largest, the first grid cell in the velocity grid W₁ is a grid cell with a largest velocity vector in the grid cell (3, 3) and the grid cell (4, 4). The largest velocity vector may refer to a velocity vector with a maximum norm or a maximum speed. The norm may be a Euclidean norm or a norm of another type. For example, a Euclidean norm of a velocity vector of the grid cell (3, 3) is \sqrt{Vₓ²(3)+V_{y}²(3)}, and a Euclidean norm of a velocity vector of the grid cell (4, 4) is \sqrt{Vₓ²(4)+V_{y}²(4)}. If \sqrt{Vₓ²(3)+V_{y}²(3)} is greater than \sqrt{Vₓ²(4)+V_{y}²(4)}, the grid cell (3, 3) is the first grid cell in the velocity grid W₁.

In an optional implementation, when the velocity grid W₁ has a plurality of grid cells with the largest weight, the first grid cell in the velocity grid W₁ is a grid cell that is among the plurality of grid cells with the largest weight and that corresponds to a velocity vector closest to the reference velocity vector. The reference velocity vector of the sensor may be a velocity vector measured by an IMU or another device, or may be a velocity vector obtained based on iterations in the present invention. The velocity vector closest to the reference velocity vector refers to a velocity vector with a smallest distance from the reference velocity vector. The distance may be a Euclidean distance, a Mahalanobis distance, or a distance of another type. For example, in the velocity grid W₁ shown in FIG. 5, if weights of a grid cell (3, 3) and a grid cell (4, 4) are the largest, the reference velocity vector is (V_{xc}, V_{yc}), a Euclidean distance between the grid cell (3, 3) and the reference velocity vector (V_{xc}, V_{yc}) is {square root over ((Vₓ(3)−V_{xc})²+(V_{y}(3)−V_{yc}²)}, a Euclidean distance between the grid cell (4, 4) and the reference velocity vector (V_{xc}, V_{yc}) is {square root over ((Vₓ(4)−V_{xc})²+(V_{y}(4)−V_{yc})²)}, and {square root over ((Vₓ(3)−V_{xc})²+(V_{y}(3)−V_{yc}² )} is less than {square root over ((Vₓ(4)−V_{xc})²+(V_{y}(4)−V_{yc})²)}, the grid cell (3, 3) is the first grid cell in the velocity grid W₁.

The motion state of the sensor includes the velocity vector of the sensor. Optionally, in addition to the velocity vector of the sensor, the motion state of the sensor may further include other data, such as a position of the sensor.

The following describes six manners of determining the motion state of the sensor based on the velocity vector corresponding to the first grid cell in the velocity grid W₁, and certainly a specific implementation in which a motion state determining apparatus determines the motion state of the sensor based on the velocity vector corresponding to the first grid cell in the velocity grid W₁ may be different. This is not limited in this embodiment of this application.

Manner 1: An example implementation of determining the motion state of the sensor based on the first grid cell in the velocity grid W₁ includes: determining that the velocity vector corresponding to the first grid cell in the velocity grid W₁ is the velocity vector of the sensor.

In manner 1, the velocity vector of the first grid cell in the velocity grid W₁ among the plurality of velocity vectors in the velocity grid W₁ is most likely to be the velocity vector of the sensor. Therefore, the velocity vector corresponding to the first grid cell in the velocity grid W₁ may be directly determined as the velocity vector of the sensor.

Manner 2: An example implementation of determining the motion state of the sensor based on the first grid cell in the velocity grid W₁ includes: determining that an opposite number of each component of the velocity vector corresponding to the first grid cell in the velocity grid W₁ is each velocity component of the velocity vector of the sensor. That is, each velocity component of the velocity vector of the sensor is equal to the opposite number of each velocity component of the velocity vector corresponding to the first grid cell in the velocity grid W₁. In manner 2, the velocity vector corresponding to the first grid cell in the velocity grid W₁ among the plurality of velocity vectors in the velocity grid W₁ is most likely the velocity vector corresponding to the target stationary relative to the reference system. Because the velocity component of the velocity vector of the sensor and the velocity component of the velocity vector of the target stationary relative to the reference system are the same in magnitude, but opposite in direction, the opposite number of the velocity component of the velocity vector corresponding to the first grid cell in the velocity grid W₁ may be determined as the velocity component of the velocity vector of the sensor. For example, if the velocity vector corresponding to the first grid cell in the velocity grid W₁ is (5, 4), the velocity vector of the sensor is (−5, 4).

Manner 3: An example implementation of determining the motion state of the sensor based on the first grid cell in the velocity grid W₁ is: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, and the weight of the grid cell in the velocity grid Wₘ is determined based on the measurement data from the sensor, where m=1, 2, . . . , M, and M is an integer; and determining that a velocity vector corresponding to the first grid cell in the velocity grid W_{M} is the velocity vector of the sensor.

Optionally, the first grid cell in the velocity grid Wₘ may be a grid cell with a largest weight in the velocity grid Wₘ, the first grid cell in the velocity grid Wₘ may be a grid cell that is in a neighborhood of a grid cell with a largest weight in the velocity grid Wₘ and that is closest to the reference velocity vector, or the first grid cell in the velocity grid Wₘ may be a grid cell that is among a plurality of grid cells with maximum weights in the velocity grid Wₘ and that corresponds to a velocity vector closest to the reference velocity vector. A specific implementation principle of the first grid cell in the velocity grid Wₘ is similar to that of the first grid cell in the velocity grid W₁, and details are not described herein.

Specifically, the reference velocity vector may be equal to a velocity vector corresponding to a grid cell in the velocity grid Wₘ. Preferably, the reference velocity vector may be equal to a velocity vector corresponding to a grid cell located at a central position of the velocity grid Wₘ, or may be equal to a velocity vector corresponding to a grid cell located near a central position. A two-dimensional grid is used as an example. The grid may be similarly obtained according to formula (1) and formula (2), and details are not described herein.

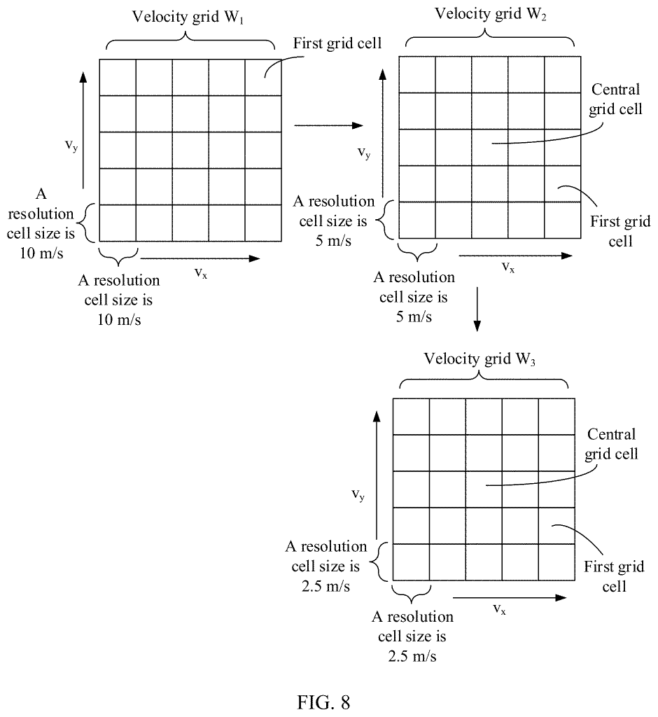

For example, the velocity grid Wₘ is a two-dimensional grid, where m=1, 2, . . . , M, and M is 3. As shown in FIG. 8, after a first grid cell in a velocity grid W₁ is determined, a velocity grid W₂ is determined based on a velocity vector corresponding to the first grid cell, where a quantity of grid cells included in the velocity grid W₂ may be the same as or different from a quantity of resolution cells included in the velocity grid W₁. In FIG. 8, for example, the quantity of grid cells included in the velocity grid W₂ is the same as the quantity of resolution cells included in the velocity grid W₁. The velocity vector corresponding to the first grid cell in the velocity grid W₁ is used as a reference velocity vector, and the reference velocity vector is equal to a velocity vector corresponding to a grid cell located at a central position of the velocity grid W₂. A resolution cell size of the velocity grid W₂ is less than a resolution cell size of the velocity grid W₁. For example, as shown in FIG. 8, resolution cell sizes of the velocity grid W₂ in a vₓ dimension and in a v_{y} dimension are respectively half resolution cell sizes of the velocity grid W₁ in a v_{z} dimension and in a v_{y} dimension. The velocity grid W₂ may be determined based on the velocity vector corresponding to the grid cell located at the central position of the velocity grid W₂ and a resolution cell size and quantity of the velocity grid W₂ in each dimension, which is similar to formula (1) and formula (2) as described above. After the velocity grid W₂ is determined, a weight of each grid cell in the velocity grid W₂ is determined based on the measurement data from the sensor by using a same principle of determining the weight of the grid cell in the velocity grid W₁. Then, a first grid cell in the velocity grid W2 is determined, where the first grid cell in the velocity grid W₂ is a grid cell with the largest weight in the velocity grid W₂.

As shown in FIG. 8, after the first grid cell in the velocity grid W₂ is determined, a velocity grid W₃ may be determined based on a velocity vector corresponding to the first grid cell in the velocity grid W₂, where the quantity of grid cells included in the velocity grid W₃ may be the same as or different from the quantity of resolution cells included in the velocity grid W₂. In FIG. 8, for example, the quantity of grid cells included in the velocity grid W₃ is the same as the quantity of resolution cells included in the velocity grid W₂. The velocity vector corresponding to the first grid cell in the velocity grid W₂ is used as a reference velocity vector, and the reference velocity vector is equal to a velocity vector corresponding to a grid cell located at a central position of the velocity grid W₃. A resolution cell size of the velocity grid W₃ is less than the resolution cell size of the velocity grid W₂. For example, as shown in FIG. 8, resolution cell sizes of the velocity grid W₃ in a vₓ dimension and in a v_{y} dimension are respectively half the resolution cell sizes of the velocity grid W₂ in the vₓ dimension and in the v_{y} dimension. The velocity grid W₃ may be determined based on the velocity vector corresponding to the grid cell located at the central position of the velocity grid W₃ and a resolution cell size and quantity of the velocity grid W₃ in each dimension, which is similar to formula (3) and formula (4) as described above. After the velocity grid W₃ is determined, a weight of each grid cell in the velocity grid W₃ is determined based on the measurement data from the sensor by using the same principle of determining the weight of the grid cell in the velocity grid W₁. Then, a first grid cell in the velocity grid W₃ is determined, where the first grid cell in the velocity grid W₃ is a grid cell with the largest weight in the velocity grid W₃. Finally, a velocity vector corresponding to the first grid cell in the velocity grid W₃ is determined as the velocity vector of the sensor.

As described above, the velocity vector of the first grid cell in the velocity grid Wₘ₋₁ may be taken as the reference velocity vector of the velocity grid Wₘ; the velocity grid Wₘ is determined based on the reference velocity vector of the velocity grid Wₘ and the resolution cell size and quantity of the velocity grid Wₘ in each dimension; the weight of the grid cell in the velocity grid Wₘ is determined based on the measurement data from the sensor; and the motion state of the sensor, especially the velocity vector of the sensor, is determined based on the weight of the grid cell in the velocity grid Wₘ. The velocity vector of the sensor is the velocity vector corresponding to the first grid cell in the velocity grid W_{M}.

Optionally, the reference velocity vector of the velocity grid Wₘ is not necessarily the velocity vector corresponding to the grid cell located at the central position of the velocity grid Wₘ. For reasons such as discretization, the reference velocity vector of the velocity grid Wₘ may be a velocity vector corresponding to a grid cell in a neighborhood of the central position of the velocity grid Wₘ, or may be a velocity vector corresponding to a grid cell slightly deviating from the central position of the velocity grid Wₘ.

It can be learned that in manner 3, after the velocity vector corresponding to the first grid cell in the velocity grid W₁ is determined, m−1 iterations are performed to determine the velocity vector of the sensor. Because the velocity vector of the first grid cell in the velocity grid Wₘ₋1 may be used as the reference velocity vector of the velocity grid Wₘ, the resolution cell size of the velocity grid Wₘ in each dimension may be less than the resolution cell size of the velocity grid Wₘ₋₁ in each dimension, and the resolution cell quantity of the velocity grid Wₘ in each dimension may be equal to a resolution cell quantity of the velocity grid Wₘ₋₁ in each dimension, an initial velocity grid may be obtained based on a larger resolution cell according to manner 3, to quickly obtain an initial velocity vector of the sensor. A resolution cell size is gradually reduced in an iterative process, to improve precision of the velocity vector of the sensor, that is, to more accurately determine the velocity vector of the sensor. In addition, the problem of large computation operations caused by directly determining the velocity grid based on a smallest resolution cell size can be avoided.

Manner 4: an example implementation of determining the velocity vector of the sensor based on the first grid cell in the velocity grid W₁ includes: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, and the weight of the grid cell in the velocity grid Wₘ is determined based on the measurement data from the sensor, where m=1, 2, . . . , M, and M is an integer; and determining that magnitude of each component of the velocity vector of the sensor is an opposite number of each component of a velocity vector corresponding to the first grid cell in the velocity grid W_{M}.

Optionally, the first grid cell in the velocity grid Wₘ is a grid cell with a largest weight in the velocity grid Wₘ, the first grid cell in the velocity grid Wₘ may be a grid cell that is in a neighborhood of a grid cell with a largest weight in the velocity grid Wₘ and that is closest to the reference velocity vector, or the first grid cell in the velocity grid Wₘ may be a grid cell that is among a plurality of grid cells with maximum weights in the velocity grid Wₘ and that corresponds to a velocity vector closest to the reference velocity vector. The implementation principle of the first grid cell in the velocity grid Wₘ is similar to that of the first grid cell in the velocity grid W₁, and details are not described herein.

Specifically, the reference velocity vector may be equal to a velocity vector corresponding to a grid cell in the velocity grid Wₘ. Preferably, the reference velocity vector may be equal to a velocity vector corresponding to a grid cell located at a central position of the velocity grid Wₘ, or may be equal to a velocity vector corresponding to a grid cell located near a central position. A two-dimensional grid is used as an example. The grid may be similarly obtained according to formula (1) and formula (2), and details are not described herein. For reasons such as discretization, the velocity vector corresponding to the first grid cell in the velocity grid Wₘ₋₁ may be a velocity vector corresponding to a grid cell slightly deviating from a central grid cell in the velocity grid Wₘ.

A difference between manner 3 and manner 4 lies in that, in manner 3, velocity vectors corresponding to grid cells in the velocity grid W₁ to the velocity grid Wₘ are candidate velocity vectors of the sensor, while in manner 4, velocity vectors corresponding to grid cells in the velocity grid W₁ to the velocity grid Wₘ are candidate velocity vectors of the target measured by the sensor. A principle of determining the first grid cell in the velocity grid Wₘ in manner 4 is the same as that of determining the first grid cell in the velocity grid Wₘ in manner 3, and details are not described herein again. The velocity vector corresponding to the first grid cell in the velocity grid Wₘ is the velocity vector of the target stationary relative to the reference system. Because the velocity vector of the sensor and the velocity vector of the target stationary relative to the reference system are the same in magnitude, but opposite in direction, each component of the velocity vector of the sensor may be determined as the opposite number of each component of the velocity vector corresponding to the first grid cell in the velocity grid W_{M}.

It can be learned that in manner 4, after the velocity vector corresponding to the first grid cell in the velocity grid W₁ is determined, m−1 iterations are performed to determine the velocity vector of the sensor. Because the velocity vector of the first grid cell in the velocity grid Wₘ₋₁may be used as the reference velocity vector of the velocity grid Wₘ, the resolution cell size of the velocity grid Wₘ in each dimension may be less than the resolution cell size of the velocity grid W_{m -1} in each dimension, and a resolution cell quantity of the velocity grid Wₘ in each dimension may be equal to a resolution cell quantity of the velocity grid Wₘ₋₁ in each dimension, an initial velocity grid may be obtained based on a larger resolution cell according to manner 4, to quickly obtain an initial velocity vector of the sensor. A resolution cell size is gradually reduced in an iterative process, to improve precision of the velocity vector of the sensor, that is, to determine the velocity vector of the sensor more accurately. In addition, a problem of great computation consumption caused by directly determining the velocity grid based on a smallest resolution cell size is avoided.

In an optional implementation, after the velocity vector of the sensor is determined, measurement data of the target stationary relative to the reference system may be further determined based on the velocity vector of the sensor from the measurement data. According to this optional implementation, the measurement data of a target moving relative to the reference system and the measurement data of the target stationary relative to the reference system can be separated.

Optionally, a two-dimensional velocity vector is used as an example. The velocity vector of the sensor is (vₓ*, v_{y}*). If an n^{th} piece of measurement data satisfies

|vₓ*·cosθₙ+v_{y}*·sinθₙ+\dot{r}ₙ|≤D_{T} (59),

the n^{th} piece of measurement data is the measurement data of the target stationary relative to the reference system; otherwise, the n^{th} piece of measurement data is the measurement data of the moving target, where D_{T} is a non-negative threshold, and θₙ and \dot{r}ₙ are respectively a measurement value of an azimuth angle and a measurement value of a radial velocity that are included in the n^{th} piece of measurement data.

Optionally, using a three-dimensional velocity vector as an example, if the velocity vector of the sensor is (vₓ*, v_{y}*, v_{z}*), and an n^{th} piece of measurement data satisfies

|vₓ*·cosφₙcosθₙ+v_{y}*·cosφₙsinθₙ+v_{z}*·sinφₙ+\dot{r}ₙ|≤D_{T} (60),

the n^{th} piece of measurement data is the measurement data of the target stationary relative to the reference system; otherwise, the n^{th} piece of measurement data is the measurement data of the moving target, where D_{T} is a non-negative threshold, and θₙ, φₙ and \dot{r}ₙ are respectively a measurement value of an azimuth angle, a measurement value of pitch angle, and a measurement value of a radial velocity that are included in the n^{th} piece of measurement data.

It should be noted that, in the foregoing method, the motion state of the sensor may be further determined based on a direction cosine measurement value of the sensor instead of the measurement value of the azimuth angle or measurement values of the azimuth angle and the pitch angle. In this case, parameters in the foregoing formula may be replaced according to the following formula: (The following formula only reflects a relationship between a direction cosine and an azimuth angle or an azimuth angle and a pitch angle, and does not reflect n. A person skilled in the art may know that a direction cosine value of the n^{th} piece of measurement data needs to correspond to an azimuth angle, a pitch angle, and the like in the n^{th} piece of measurement data.)

For the two-dimensional velocity vector:

Λₓ=cosθ, and Λ_{y}=sinθ,

where Λₓ, Λ_{y} are direction cosines, and θ is the azimuth angle.

For the three-dimensional velocity vector:

Λₓ=cosφcosθ, Λ_{y}=cosφsinθ, and Λ_{z}=sinφ,

where Λₓ, Λ_{y} and Λₓ are direction cosines, θ is the azimuth angle, and φ is the pitch angle.

Manner 5: an example implementation of determining the velocity vector of the sensor based on the first grid cell in the velocity grid W₁ includes: determining, based on the velocity vector corresponding to the first grid cell in the velocity grid W₁, measurement data of the target stationary relative to the reference system from the measurement data; and determining the velocity vector of the sensor based on the measurement data of the target stationary relative to the reference system. According to this optional implementation, the velocity vector of the sensor can be determined accurately. Optionally, the reference system may be a geodetic coordinate system, or an inertial coordinate system relative to the earth.

Optionally, the velocity vector corresponding to the grid cell in the velocity grid W₁ is the candidate velocity vector of the sensor. The velocity vector corresponding to the first grid cell in the velocity grid W₁ among the plurality of velocity vectors in the velocity grid W₁ is most likely the velocity vector of the sensor. The first grid cell in the velocity grid W₁ is (i*, j*), and the corresponding velocity vector is (vₓ*, v_{y}*). If an n^{th} piece of measurement data satisfies the formula (59), the n^{th} piece of measurement data is the measurement data of the target stationary relative to the reference system.

Optionally, the velocity vector corresponding to the grid cell in the velocity grid W₁ is the candidate velocity vector of the sensor. The velocity vector corresponding to the first grid cell in the velocity grid W₁ among the plurality of velocity vectors in the velocity grid W₁ is most likely to be the velocity vector of the sensor. The first grid cell in the velocity grid W₁ is (i*, j*, k*), and the corresponding velocity vector is (vₓ*, v_{y}*, v_{z}*). If an n^{th} piece of measurement data satisfies the formula (60), the n^{th} piece of measurement data is the measurement data of the target stationary relative to the reference system.

Optionally, the velocity vector corresponding to the grid cell in the velocity grid W₁ is the candidate velocity vector of the target measured by the sensor. The velocity vector corresponding to the first grid cell in the velocity grid W₁ among the plurality of velocity vectors in the velocity grid W₁ is most likely the velocity vector of the target stationary relative to the reference system. If the first grid cell in the velocity grid W₁ is (i*, j*), the corresponding velocity vector is (vₓ*, v_{y}*), and an n^{th} piece of measurement data satisfies |vₓ*·cosθₙ+v_{y}*·sinθₙ−\dot{r}ₙ|≤D_{T}, the n^{th} piece of measurement data is the measurement data of the target stationary relative to the reference system, where D_{T} is a non-negative threshold.

Optionally, the velocity vector corresponding to the grid cell in the velocity grid W₁ is the candidate velocity vector of the target measured by the sensor. The velocity vector corresponding to the first grid cell in the velocity grid W₁ among the plurality of velocity vectors in the velocity grid W₁ is most likely to be the velocity vector of the target stationary relative to the reference system. If the first grid cell in the velocity grid W₁ is (i*, j*, k*), the corresponding velocity vector is (vₓ* , v_{y}*, v_{z}*), and an n^{th} piece of measurement data satisfies |vₓ*·cosφₙcosθₙ+v_{y}*cosφₙsinθₙ+vₓ*·sinφₙ−\dot{r}ₙ|≤D_{T}, the n^{th} piece of measurement data is the measurement data of the target stationary relative to the reference system, where D_{T} is a non-negative threshold.

Optionally, in manner 5, a first example implementation of determining the velocity vector of the sensor based on the measurement data of the target stationary relative to the reference system may include: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, the weight of the grid cell in the velocity grid Wₘ is determined based on newly determined measurement data of the target stationary relative to the reference system, and the newly determined measurement data of the target stationary relative to the reference system is determined based on the velocity vector corresponding to the first grid cell in the velocity grid Wₘ₋₁, where m=1, 2, . . . , M, and M is an integer; and determining that a velocity vector corresponding to the first grid cell in the velocity grid W_{M} is the velocity vector of the sensor.

Optionally, the first grid cell in the velocity grid Wₘ is a grid cell with the largest weight in the velocity grid Wₘ, the first grid cell in the velocity grid Wₘ may be a grid cell that is in a neighborhood of a grid cell with a largest weight in the velocity grid Wₘ and that is closest to the reference velocity vector, or the first grid cell in the velocity grid Wₘ may be a grid cell that is among a plurality of grid cells with maximum weights in the velocity grid Wₘ and that corresponds to a velocity vector closest to the reference velocity vector. The implementation principle of the first grid cell in the velocity grid Wₘ is similar to that of the first grid cell in the velocity grid W₁, and details are not described herein.

Specifically, the reference velocity vector may be equal to a velocity vector corresponding to a grid cell in the velocity grid Wₘ. Preferably, the reference velocity vector may be equal to a velocity vector corresponding to a grid cell located at a central position of the velocity grid Wₘ, or may be equal to a velocity vector corresponding to a grid cell located near a central position. A two-dimensional grid is used as an example. The grid may be similarly obtained according to formula (1) and formula (2), and details are not described herein.

For example, the velocity grid Wₘ is a two-dimensional grid, where m=1, 2, . . . , M, and M is 3. After a first grid cell in a velocity grid W₁ is determined, measurement data of a target stationary relative to a reference system is determined based on the first grid cell in the velocity grid W₁ from the measurement data from the sensor. As shown in FIG. 8, after the first grid cell in the velocity grid W₁ is determined, a velocity grid W₂ is determined. Each grid cell in the velocity grid W₂ corresponds to one velocity vector. A quantity of grid cells included in the velocity grid W₂ may be the same as or different from a quantity of resolution cells included in the velocity grid W₁. In FIG. 8, for example, the quantity of grid cells included in the velocity grid W₂ is the same as the quantity of resolution cells included in the velocity grid W₁.

A velocity vector corresponding to the first grid cell in the velocity grid W₁ is used as a reference velocity vector, and the reference velocity vector is equal to a velocity vector corresponding to a grid cell located at a central position of the velocity grid W₂. A resolution cell size of the velocity grid W₂ is less than a resolution cell size of the velocity grid W₁. A resolution cell size of the velocity grid W₂ is less than a resolution cell size of the velocity grid W₁. For example, as shown in FIG. 8, resolution cell sizes of the velocity grid W₂ in a vₓ dimension and in a v_{y} dimension are respectively half resolution cell sizes of the velocity grid W₁ in a vₓ dimension and in a v_{y} dimension. The velocity grid W₂ can be determined based on the velocity vector corresponding to the grid cell located at the central position of the velocity grid W₂ and a resolution cell size and quantity of the velocity grid W₂ in each dimension. After the velocity grid W₂ is determined, a weight of a grid cell in the velocity grid W₂ is determined based on the measurement data of the target stationary relative to the reference system. Then, a first grid cell in the velocity grid W₂ is determined, where the first grid cell in the velocity grid W₂ is a grid cell with the largest weight in the velocity grid W₂.

As shown in FIG. 8, after the first grid cell in the velocity grid W₂ is determined, the measurement data corresponding to a target stationary relative to the reference system is again separated from a frame of measurement data obtained from the sensor based on a velocity vector corresponding to the first grid cell in the velocity grid W₂. Alternatively, the measurement data of a target stationary relative to the reference system is again separated from the measurement data of the target that is stationary relative to the reference system and that is determined previously. After the first grid cell in the velocity grid W₂ is determined, a velocity grid W₃ may be determined based on the velocity vector corresponding to the first grid cell in the velocity grid W₂, where a quantity of grid cells included in the velocity grid W₃ may be the same as or different from the quantity of resolution cells included in the velocity grid W₂. In FIG. 8, for example, the quantity of grid cells included in the velocity grid W₃ is the same as the quantity of resolution cells included in the velocity grid W₂. A velocity vector corresponding to a grid cell located at a central position of the velocity grid W₃ is equal to the velocity vector corresponding to the first grid cell in the velocity grid W₂. A resolution cell size of the velocity grid W₃ is less than or equal to the resolution cell size of the velocity grid W₂. For example, as shown in FIG. 8, resolution cell sizes of the velocity grid W₃ in a vₓ dimension and in a v_{y} dimension are respectively half the resolution cell sizes of the velocity grid W₂ in the vₓ dimension and in the v_{y} dimension. The velocity grid W₃ may be determined based on the velocity vector corresponding to the grid cell located at the central position of the velocity grid W₃ and a resolution cell size and quantity of the velocity grid W₃ in each dimension. After the velocity grid W₃ is determined, a weight of a grid cell in the velocity grid W₃ is determined based on newly determined measurement data of the target stationary relative to the reference system. Then, a first grid cell in the velocity grid W₃ is determined, where the first grid cell in the velocity grid W₃ is a grid cell with the largest weight in the velocity grid W₃. Finally, a velocity vector corresponding to the first grid cell in the velocity grid W₃ is determined as the velocity vector of the sensor.

As described above, the velocity vector of the first grid in the velocity grid Wₘ₋₁ may be taken as the reference velocity vector of the velocity grid Wₘ; the velocity grid Wₘ is determined based on the reference velocity vector of the velocity grid Wₘ and the resolution cell size and quantity of the velocity grid Wₘ in each dimension; the weight of the grid cell in the velocity grid Wₘ is determined based on the newly determined measurement data of the target stationary relative to the reference system; and the motion state of the sensor, especially the velocity vector of the sensor, is determined based on the weight of the grid cell in the velocity grid Wₘ. The velocity vector of the sensor is the velocity vector corresponding to the first grid cell in the velocity grid W_{M}.

Optionally, the reference velocity vector of the velocity grid Wₘ is not necessarily the velocity vector corresponding to the grid cell located at the central position of the velocity grid Wₘ. For reasons such as discretization, the reference velocity vector of the velocity grid Wₘ may be a velocity vector corresponding to a grid cell in a neighborhood of the central position of the velocity grid Wₘ, or may be a velocity vector corresponding to a grid cell slightly deviating from the central position of the velocity grid Wₘ.

It can be learned that, in the first specific implementation of determining the velocity vector of the sensor based on the measurement data of the target stationary relative to the reference system, the measurement data of the target stationary relative to the reference system is determined based on the velocity vector corresponding to the first grid cell in the velocity grid W₁ from the measurement data, and m−1 iterations may be performed based on the measurement data of the target stationary relative to the reference system, to determine the velocity vector of the sensor. According to the first specific implementation, the data of the target stationary relative to the reference system can be effectively separated, and weighting of a grid cell based on measurement data of a moving target can be reduced or avoided, thereby reducing or avoiding interference of the measurement data of the moving target. In this way, the velocity vector of the sensor can be determined more accurately.

Optionally, in manner 5, a second example implementation of determining the velocity vector of the sensor based on the measurement data of the target stationary relative to the reference system includes: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, the weight of the grid cell in the velocity grid Wₘ is determined based on newly determined measurement data of the target stationary relative to the reference system, and the newly determined measurement data of the target stationary relative to the reference system is determined based on the velocity vector corresponding to the first grid cell in the velocity grid Wₘ₋₁, where m=1, 2, . . . , M, and M is an integer; and determining that an opposite number of each velocity component of a velocity vector corresponding to the first grid cell in the velocity grid W_{M} is each velocity component of the velocity vector of the sensor.

Optionally, the first grid cell in the velocity grid Wₘ may be a grid cell with the largest weight in the velocity grid Wₘ, the first grid cell in the velocity grid Wₘ may be a grid cell that is in a neighborhood of a grid cell with the largest weight in the velocity grid Wₘ and that is closest to the reference velocity vector, or the first grid cell in the velocity grid Wₘ may be a grid cell that is among a plurality of grid cells with maximum weights in the velocity grid Wₘ and that corresponds to a velocity vector closest to the reference velocity vector. A specific implementation principle of the first grid cell in the velocity grid Wₘ is similar to that of the first grid cell in the velocity grid W₁, and details are not described herein.

Specifically, the reference velocity vector may be equal to a velocity vector corresponding to a grid cell in the velocity grid Wₘ. Preferably, the reference velocity vector may be equal to a velocity vector corresponding to a grid cell located at a central position of the velocity grid Wₘ, or may be equal to a velocity vector corresponding to a grid cell located near a central position. For reasons such as discretization, the velocity vector corresponding to the first grid cell in the velocity grid Wₘ₋₁ may be a velocity vector corresponding to a grid cell slightly deviating from a central grid cell in the velocity grid Wₘ.

A difference between the first example implementation of determining the velocity vector of the sensor based on the measurement data of the target stationary relative to the reference system and the second example implementation of determining the velocity vector of the sensor based on the measurement data of the target stationary relative to the reference system lies in that, in the first example implementation, the velocity vectors corresponding to the grid cells in the velocity grid W₁ to the velocity grid Wₘ are candidate velocity vectors of the sensor, while in the second example implementation, the velocity vectors corresponding to the grid cells in the velocity grid W₁ to the velocity grid Wₘ are candidate velocity vectors of the target measured by the sensor. The principle of determining the first grid cell in the velocity grid Wₘ in the first example implementation is the same as that of determining the first grid cell in the velocity grid Wₘ in the second example implementation, and details are not described herein again. In the second example implementation, the velocity vector corresponding to the first grid cell in the velocity grid Wₘ is the velocity vector of the target stationary relative to the reference system. Because the velocity vector of the sensor and the velocity vector of the target stationary relative to the reference system are the same in magnitude, but opposite in direction, the opposite number of the velocity component of the velocity vector corresponding to the first grid cell in the velocity grid W_{M} may be determined as the velocity component of the velocity vector of the sensor.

It can be learned that, in the example specific implementation of determining the velocity vector of the sensor based on the measurement data of the target stationary relative to the reference system, after the measurement data of the target stationary relative to the reference system is determined based on the velocity vector corresponding to the first grid cell in the velocity grid W₁ from the measurement data, M−1 iterations are performed based on the measurement data of the target stationary relative to the reference system, to determine the velocity vector of the sensor. Therefore, an initial velocity grid may be obtained based on a larger resolution cell according to the second specific implementation, to quickly obtain an initial velocity vector of the sensor. A resolution cell size is gradually reduced in an iterative process, to improve precision of the velocity vector of the sensor, that is, to more accurately determine the velocity vector of the sensor. In addition, the problem of large computations caused by directly determining the velocity grid based on the smallest resolution cell size can be avoided.

Optionally, in manner 5, a third example implementation of determining, by the motion state determining apparatus, the velocity vector of the sensor based on the measurement data of the target stationary relative to the reference system may be:

determining the velocity vector of the sensor according to the following measurement equation:

−\dot{r}ₖ=hₖvₛ−n_{\dot{r}} (61), or

\dot{r}ₖ=hₖv_{T}+n_{\dot{r}} (62),

where vₛ is the velocity vector of the sensor, and v_{T} is the velocity vector of the target stationary relative to the reference system. It is readily known that vₛ=−v_{T}.

Therefore, the velocity vector vₛ of the sensor can be obtained directly according to formula (61); or equivalently, the velocity vector v_{T} of the target stationary relative to the reference system is obtained according to formula (62), and the velocity vector vₛ of the sensor is obtained according to vₛ=−v_{T}. (61) is used in the following as an example for description, the velocity vector v_{T} of the target stationary relative to the reference system may be obtained equivalently according to (62). Details are not further described in this specification.

In (62), \dot{r}ₖ is a measurement value of a radial velocity of a k^{th} target stationary relative to the reference system; n_{\dot{r}} is a measurement error of the radial velocity, and a mean value of the measurement error is 0; and a variance is σ_{\dot{r}}², and the value of the variance depends on performance of the sensor

A two-dimensional velocity vector is used as an example. vₛ and hₖ may be respectively

vₛ=[v_{s,x} v_{s,y}]^{T} (63), and

hₖ=[cosθₖ sinθₖ] (64), where

v_{s,x} and v_{s,y} are two components of the velocity vector of the sensor, [ ]^{T} represents transposition of a matrix or vector, and θₖ is a measurement value of an azimuth angle of the k^{th} target stationary relative to the reference system.

A three-dimensional velocity vector is used as an example. vₛ and hₖ may be respectively

vₛ=[v_{s,x} v_{s,y} v_{s,z}]^{T} (65), and

hₖ=[cosφₖcosθₖ cosφₖsinθₖ sinφₖ] (66),

where v_{s,x}, v_{s,y} and v_{s,z} are three velocity components of the velocity vector of the sensor, θₖ is a measurement value of an azimuth angle of the k^{th} target stationary relative to the reference system, and φₖ is a measurement value of a pitch angle of the k^{th} target stationary relative to the reference system.

Specifically, the velocity vector of the sensor may be determined based on a least square (LS) estimation and/or sequential block filtering according to the measurement equation (61) or (62).

It should be noted that, in the foregoing method, the motion state of the sensor may be further determined based on a direction cosine measurement value of the sensor instead of the measurement value of the azimuth angle or measurement values of the azimuth angle and the pitch angle. In this case, parameters in the foregoing formula may be replaced according to the following formula: (The following formula only reflects a relationship between a direction cosine and an azimuth angle or an azimuth angle and a pitch angle, and does not reflect k. A person skilled in the art may know that a direction cosine value of the k^{th} target stationary relative to the reference system should correspond to an azimuth angle, a pitch angle, and the like of the k^{th} target stationary relative to the reference system.)

For the two-dimensional velocity vector:

Λₓ=cosθ, and Λ_{y}=sinθ, where

Λₓ, Λ_{y} are direction cosines, and θ is the azimuth angle.

For the three-dimensional velocity vector:

Λₓ=cosφcosθ, Λ_{y}=cosφsinθ, and Λ_{z}=sinφ, where

Λₓ, Λ_{y} and Λ_{z} are direction cosines, θ is the azimuth angle, and φ is the pitch angle.

Solution 1: The velocity vector of the sensor is determined based on the least square (LS) estimation.

Specifically, a least square estimation value of the velocity vector of the sensor may be obtained based on a radial velocity vector and a measurement matrix corresponding to the radial velocity vector. Optionally, the least square estimation value of the velocity vector of the sensor is:

vₛ^{LS}=−H_{N}_{₁}⁻¹\dot{r}_{N}_{₁} (67), or

vₛ^{LS}=−(H_{N}_{₁}^{T}H_{N}_{₁})⁻¹H_{N}_{₁}^{T}*\dot{r}_{N}_{₁} (68), where

vₛ^{LS} is the least square estimation value of the velocity vector of the sensor, that is, vₛ^{LS} is a determined velocity vector of the sensor.

Alternatively,

vₛ^{RLS}=−(H_{N}_{₁}^{T}H_{N}_{₁}+R)⁻¹H_{N}_{₁}^{T}*\dot{r}ₖ (69), where

vₛ^{RLS} is a regularized least square estimation value of the velocity vector of the sensor, that is, vₛ^{RLS} is a determined velocity vector of the sensor. R is a positive semidefinite matrix or a positive definite matrix used for regularization. For example,

R=α·I (70), where

I is an identity matrix of order N₁, αis a non-negative or positive constant, for example, α=γ·σ_{\dot{r}}², where γ≥0.

The radial velocity vector \dot{r}_{N}_{₁} is a vector combining N₁ measurement values of radial velocities in N₁ pieces of measurement data corresponding to the target stationary relative to the reference system, the matrix H_{N}_{₁} is a measurement matrix corresponding to the radial velocity vector \dot{r}_{N}_{₁}, and N₁ is a positive integer greater than 1.

The radial velocity vector \dot{r}_{N}_{₁} and the corresponding measurement matrix H_{N}_{₁} satisfy the following measurement equation:

−\dot{r}_{N}_{₁}=H_{N}_{₁}vₛ−n_{\dot{r}} (71).

Specifically, the radial velocity vector \dot{r}_{N}_{₁} can be expressed as \dot{r}_{N}_{₁}=[\dot{r}ᵢ_{₁} . . . \dot{r}ᵢ_{_{N1}}]^{T, where \dot{r}}ᵢ_{₁} represents an i₁^{th} radial velocity measurement value corresponding to the target stationary relative to the reference system, and n_{\dot{r}} is a corresponding measurement error vector that includes corresponding radial velocity measurement errors as described above. Correspondingly, the measurement matrix H_{N}_{₁} can be expressed as

$${H}_{{N}_{1}} = [ \begin{matrix}{h}_{{i}_{1}} \\ ⋮ \\ {{h}_{i}}_{{N}_{1}}\end{matrix} ] . \qquad ( 72 )$$

Optionally, using the sensor obtains azimuth angle and radial velocity measurement values as an example, the radial velocity measurement matrix H_{N}_{₁} includes hᵢ_{₁}=[cosθᵢ_{₁} sinθᵢ_{₁}], hᵢ_{₂}=[cosθᵢ_{₂} sinθᵢ_{₂}], . . . , and hᵢ_{_{N1}}=[cosθᵢ_{_{N1}} sinθᵢ_{_{N1}}], where θᵢ_{₁}, θᵢ_{₂}, . . . , and θᵢ_{_{iN1}} are the azimuth angle measurement values, and N₁≥2.

Optionally, using the sensor obtains azimuth angle, pitch angle, and radial velocity measurement values as an example, the radial velocity measurement matrix H_{N}_{₁} includes hᵢ_{₁}=[cosφᵢ_{₁} cosθᵢ_{₁} cosφᵢ_{₁} sinθᵢ_{₁} sinφᵢ_{₁}], hᵢ_{₂}=[cosφᵢ_{₂} cosθᵢ_{₂} cosφᵢ_{₂} sinθᵢ_{₂} sinφᵢ_{₂}], . . . ,and hᵢ_{_{N1}}=[cosφᵢ_{_{N1}} cosθᵢ_{_{N1}} cosφᵢ_{_{N1}} sinθᵢ_{_{N1}} sinφᵢ_{_{N1}}], where θᵢ_{₁}, θᵢ_{₂}, . . . , and θᵢ_{_{N1}} are the azimuth angle measurement values, φᵢ_{₁}, φᵢ_{₂}, . . . , and φᵢ_{_{N1}} are the pitch angle measurement values, and N₁≥3.

In an implementation, selection of the above θᵢ_{₁}, θᵢ_{₂}, . . . , and θᵢ_{_{N1 or φ}}ᵢ_{₁}, φᵢ_{₂}, . . . , and φᵢ_{_{N1}} should be made to keep spacing between them as large as possible, to obtain a more precise least square estimate. Under the condition of the angle selection with spacing as large as possible, a condition number of the measurement matrix can be as small as possible.

Optionally, the selection of each radial velocity component of the radial velocity vector is made to keep each column vector of the corresponding measurement matrix orthogonal to each other as much as possible.

Solution 2: The motion state of the sensor is determined based on the sequential block filtering.

Specifically, the motion state of the sensor may be obtained based on the sequential block filtering, and the M radial velocity vectors and corresponding measurement matrices, where a radial velocity vector that corresponds to the target stationary relative to the reference system and that includes K radial velocity measurement values is used by the sequential filtering each time.

Optionally, an m^{th} estimation formula of the sequential filtering is as follows:

v_{s,m}^{MMSE}=v_{s,m-1}^{MMSE}+Gₘ(−\dot{r}_{m,K}−H_{m,K}*v_{s,m-}^{MMSE}), m=1, 2, . . . , M (73), where

Gₘ is a gain matrix, \dot{r}_{m,K} includes the K radial velocity measurement values, and H_{m,K} includes the K radial velocity measurement matrices, as described above. For a two-dimensional velocity vector estimation, K≥2; and for a three-dimensional velocity vector estimation, K≥3.

Optionally, the gain matrix may be

Gₘ=P_{m,1|0}*H_{m,K}^{T}+R_{m,K})⁻¹ (74), where

R_{m,K} is a covariance matrix of a radial velocity vector measurement error, for example,

R_{m,K}=σ_{\dot{r}}²*I_{K} (75),

P_{m,1|1}=(I−Gₘ₋₁H_{m-1,K})P_{m,1|0} (76), and

P_{m,1|0}=P_{m-1,1|1} (77).

Optionally, in an implementation, an initial estimate and a corresponding covariance P_{0,1|1}=P₀ may be obtained based on prior information.

P₀=Q (78), and

v_{s,0}^{MMSE}=0 (79), where

Q is a preset covariance matrix of a velocity estimate, and v_{s,M}^{MMSE} is a determined velocity vector of the sensor.

Solution 3: The motion state of the sensor is determined based on the least square and the sequential block filtering.

Specifically, the measurement data that is of the sensor and that corresponds to the target stationary relative to the reference system may be divided into two parts, where the first part of data is used to obtain a least square estimation value of the velocity vector of the sensor; the second part of data is used to obtain a sequential block filtering estimation value of the velocity vector of the sensor; and the least square estimation value of the velocity vector of the sensor is used as an initial value of the sequential block filtering.

Optionally, in an implementation, an initial estimate and a corresponding covariance P_{0,1|1}=P₀ may be obtained based on a least square estimate.

P₀=P^{LS} (80), and

v₀^{MMSE}=v^{LS} (81), where

P^{LS}=G₀R_{N}_{₁}G₀^{T}, G₀=(H_{N}_{₁}^{T}H_{N}_{₁})⁻¹H_{N}_{₁}^{T} or G₀=(H_{N}_{₁})⁻¹, and R_{N}_{₁}=σ_{\dot{r}}²*I_{N}_{₁}.

Alternatively, an initial estimation and a corresponding covariance P_{0,1|1}=P₀ are obtained based on a regularized least square estimate.

P₀=P^{RLS} (82), and

v₀^{MMSE}=v^{RLS} (83), where

P^{RLS}=G₀R_{N}_{₁}G₀^{T}, G₀=(H_{N}_{₁}^{T}H_{N}_{₁}+R)⁻¹H_{N}_{₁}^{T}, R_{N}_{₁}=σ_{\dot{r}}²*I_{N}_{₁}.

v_{s,m}^{MMSE} is a sequential block filtering value of a velocity of the sensor for an m^{th} time, and I_{K} is a KxK identity matrix.

Optionally, for different values of m, the foregoing \dot{r}_{m,K} (and H_{m,K} may be different from each other. Values of K may be the same or different for different values of m, which depends on a situation. The sequential filtering estimation can effectively reduce the impact of measurement noise and improve estimation precision of the motion velocity vector of the sensor.

It should be noted that the velocity vector of the target stationary relative to the reference system may be obtained first, and the velocity vector of the sensor may be obtained according to the following relationship:

vₛ^{LS}=−v_{T}^{LS} (84), and

v_{T}^{LS}=H_{N}_{₁}⁻¹\dot{r}_{N}_{₁} (85) or

v_{T}^{LS}=(H_{N}_{₁}^{T}H_{N}_{₁})⁻¹H_{N}_{₁}^{T}*\dot{r}_{N}_{₁} (86),

where v_{T}^{LS} is a least square estimation value of the target stationary relative to the reference system, that is, it can be considered that v_{T}^{LS} is a determined velocity vector of the target stationary relative to the reference system.

Alternatively,

vₛ^{RLS}=−v_{T}^{RLS} (87), and

v_{T}^{RLS}=(H_{N}_{₁}^{T}H_{N}_{₁}+R)^{31 1}H_{N}_{₁}^{T}*\dot{r}ₖ (88),

where v_{T}^{RLS} is a regularized least square estimation value of the velocity vector of the target stationary relative to the reference system, that is, it can be considered that v_{T}^{RLS} is a determined velocity vector of the target stationary relative to the reference system.

Alternatively,

vₛ^{MSSE}=−v_{T,M}^{MMSE} (89), and

v_{T,m}^{MMSE}=v_{T,m-1}^{MMSE}+Gₘ(\dot{r}_{m,k}−H_{m,K}*v_{T,m-1}^{MMSE}), m=1,2, . . . , M (90),

where Gₘ, \dot{r}_{m,K}, H_{m,K}, and Pₘ₋₁ are as described above.

An example in which a measurement of an azimuth angle and a radial velocity of the sensor and K=2 is used in the following explanation. An m^{th} radial velocity vector is represented as \dot{r}_{m,K}=[\dot{r}_{m,1}, \dot{r}_{m,2}]^{T}, where \dot{r}_{m,1}, \dot{r}_{m,2} are respectively the first and second radial velocity measurement values in an m^{th} group of measurement data of the target stationary relative to the reference system, and a corresponding measurement matrix is

$${H}_{m , K} = [ \begin{matrix}cos {θ}_{m , 1} & sin {θ}_{m , 1} \\ cos {θ}_{m , 2} & sin {θ}_{m , 2}\end{matrix} ] , \qquad ( 91 )$$

where θ_{m,i}, i=1,2 is an i^{th} azimuth angle measurement value in the m^{th} group of measurement data of the target stationary relative to the reference system.

Similarly, an example in which a measurement of an azimuth angle, a pitch angle, and a radial velocity of the sensor and K=3 is used. An m^{th} radial velocity vector is represented as \dot{r}_{m,K}=[\dot{r}_{m,1} \dot{r}_{m,2} \dot{r}_{m,3}]^{T}, where \dot{r}_{3,m,i}, i=1,2,3 is an i^{th} radial velocity measurement value in an m^{th} group of measurement data of the target stationary relative to the reference system, and a corresponding measurement matrix is

$${H}_{m , K} = [ \begin{matrix}cos {φ}_{m , 1} \cdot cos {θ}_{m , 1} & cos {φ}_{m , 1} \cdot sin {θ}_{m , 1} & sin {φ}_{m , 1} \\ os {φ}_{m , 2} \cdot cos {θ}_{m , 2} & cos {φ}_{m , 2} \cdot sin {θ}_{m , 2} & sin {φ}_{m , 2} \\ cos {φ}_{m , 3} \cdot cos {θ}_{m , 3} & cos {φ}_{m , 3} \cdot sin {θ}_{m , 3} & sin {φ}_{m , 3}\end{matrix} ] , \qquad ( 92 )$$

where θ_{m,I}, i=1,2,3 is an i^{th} azimuth angle measurement value in the m^{th} group of measurement data of the target stationary relative to the reference system, and φ_{mIi}, i=1,2,3 is an i^{th} pitch angle measurement value in the m^{th} group of measurement data of the target stationary relative to the reference system.

In an implementation, a selection of M groups of measurement data is made to keep a condition number of a measurement matrix corresponding to each group of measurement data as small as possible.

In an implementation, a selection of θ_{m,i}, i=1,2 or θ_{m,i}, φ_{m,i}, i=1,2,3 is made to keep each column vector of the corresponding measurement matrix orthogonal to each other as much as possible.

Manner six: an example implementation of determining the motion state of the sensor based on the first grid cell in the velocity grid W₁ includes: determining the velocity vector of the sensor based on the velocity vector corresponding to the first grid cell in the velocity grid W₁, a velocity vector corresponding to a first grid cell in a velocity grid Wₘ, or a velocity vector of the sensor estimated based on measurement data of the target stationary relative to the reference system and a first velocity vector. The first velocity vector includes a velocity vector of the sensor determined based on measurement data of a previous frame and/or a reference velocity vector of the sensor, where the reference velocity vector of the sensor may be a velocity vector of the sensor measured by an IMU or another apparatus.

Optionally, the velocity vector of the sensor may be

vₛ=α·v_{s,c}+(1−α)·v_{s,p},

where α≥0, for example, α is equal to 0.5, 0.6, 0.75, or 0.8; v_{s,c} is the velocity vector corresponding to the first grid cell in the velocity grid W₁, the velocity vector corresponding to the first grid cell in the velocity grid Wₘ, or the velocity vector of the sensor estimated based on the measurement data of the target stationary relative to the reference system; and v_{s,p} is the velocity vector of the sensor determined based on the measurement data of the previous frame and/or the reference velocity vector of the sensor.

That is, the current velocity vector of the sensor is determined based on the reference velocity vector and/or the velocity vector of the sensor determined last time, because the velocity vector of the sensor may not vary greatly in a short period of time due to a temporal and/or spatial correlation of motion, and the velocity vector of the sensor calculated based on the measurement data may not differ greatly from the reference velocity vector. Therefore, the current velocity vector of the sensor needs to be determined in combination with the velocity vector of the sensor determined last time and/or the reference velocity vector of the sensor. For example, the velocity vector of the sensor determined in any one of the foregoing manners 1 to 5 is referred to as a velocity vector 1. After the velocity vector 1 is determined based on the velocity vector corresponding to the first grid cell in the velocity grid W₁, if the velocity vector 1 is not much different from the previous velocity vector of the sensor, or the velocity vector 1 is not much different from the reference velocity vector, the current velocity vector of the sensor may be determined as the velocity vector 1. Otherwise, the velocity vector 1 is not determined as the current velocity vector of the sensor.

It can be learned that, according to manner six, by using the temporal and/or spatial correlation of the motion, the velocity vector of the sensor may be determined more accurately based on the reference velocity vector and a velocity vector of the sensor obtained based on current measurement data; and/or the velocity vector of the sensor determined last time.

In this embodiment of the present invention, the function modules of a device may be divided according to the foregoing method examples. For example, the function modules may be divided according to functions, or two or more functions may be integrated into one module. The integrated module may be implemented in a form of hardware, or may be implemented in a form of a software function module. It should be noted that, module division in this embodiment of the present invention is an example, and is merely logical function division, and there may be other division manners during actual implementation.

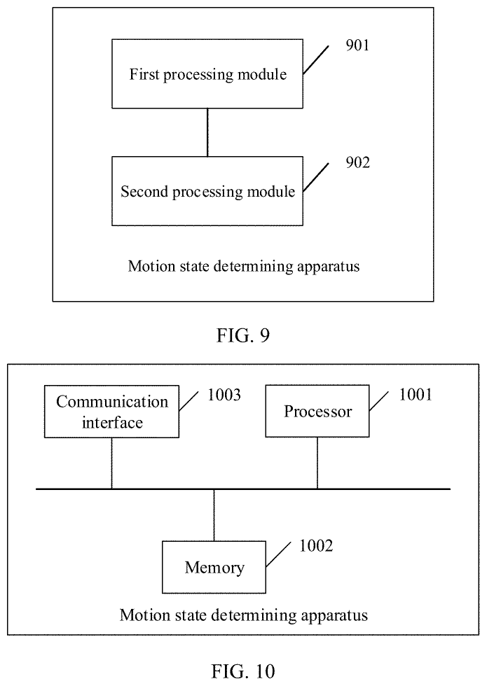

FIG. 9 is a schematic structural diagram of a motion state determining apparatus according to an embodiment of this application. The motion state determining apparatus shown in FIG. 9 may be configured to perform some or all functions of the motion state determining apparatus in the method embodiment described in FIG. 3 or FIG. 7. The motion state determining apparatus shown in FIG. 9 may include a first processing module 901 and a second processing module 902.

The first processing module 901 is configured to determine a weight of a grid cell in a velocity grid W₁ based on measurement data from a sensor, where the velocity grid W₁ includes a plurality of grid cells, each grid cell in the plurality of grid cells corresponds to one velocity vector, each velocity vector includes at least one velocity component, and the measurement data includes a velocity measurement value.

The second processing module 902 is configured to determine a motion state of the sensor based on the weight of the grid cell, where the motion state of the sensor includes a velocity vector of the sensor, and the velocity vector of the sensor includes at least one velocity component.

For how to determine the weight of the grid cell in the velocity grid W₁ and determine the motion state of the sensor based on the weight, refer to the descriptions in the foregoing method embodiments. For example, the weight of the grid cell may be determined according to one or more combinations of formulas (8) to (11), (23) to (26), and (45) to (58).

In an optional implementation, the velocity grid W₁ is determined based on at least one of a resolution cell size and a reference velocity vector.

In an optional implementation, the velocity grid W₁ is further determined based on at least one of a resolution cell quantity, a minimum velocity of a velocity component, and a velocity range of the velocity component.

For how to determine the velocity grid W₁, refer to the descriptions in the foregoing method embodiments. For example, the velocity grid W₁ may be determined according to one or more combinations of formulas (1) to (7).

In an optional implementation, a manner in which the second processing module 902 determines the motion state of the sensor based on the weight of the grid cell includes: determining the motion state of the sensor based on a first grid cell in the velocity grid W₁, where the first grid cell in the velocity grid W₁ is a grid cell with a largest weight in the velocity grid W₁, the first grid cell in the velocity grid W₁ is a grid cell that is in a neighborhood of a grid cell with a largest weight in the velocity grid W₁ and that is closest to the reference velocity vector, or the first grid cell in the velocity grid W₁ is a grid cell that is among a plurality of grid cells with maximum weights in the velocity grid W₁ and that corresponds to a velocity vector closest to the reference velocity vector.

In an optional implementation, a manner in which the first processing module 901 determines the weight of the grid cell in the velocity grid W₁ based on the measurement data from the sensor includes:

determining a second grid cell (i, j) based on an n^{th} piece of measurement data, and weighting the second grid cell (i, j) based on a weighted increment or weighting factor, where a velocity vector corresponding to the second grid cell (i, j) satisfies

|vₓ(i)·cosθₙ+v_{y}(j)·sinθₙ+\dot{r}ₙ|≤T₁; or

determining a second grid cell (i, j, k) based on an n^{th} piece of measurement data, and weighting the second grid cell (i, j, k) based on a weighted increment or weighting factor, where a velocity vector corresponding to the second grid cell (i, j, k) satisfies

|vₓ(i)·cosφₙcosθₙ+v_{y}(j)·sinφₙ sinθₙ+v_{z}(k)·sinφₙ+\dot{r}ₙ|≤T₂,

where θₙ is a measurement value of an azimuth angle included in the n^{th} piece of measurement data, φₙ is a measurement value of a pitch angle included in the n^{th} piece of measurement data, \dot{r}ₙ is a measurement value of a radial velocity included in the n^{th} piece of measurement data, vₓ (i) is an x-axis component of the velocity vector corresponding to the second grid cell, v_{y} (j) is a y-axis component of the velocity vector corresponding to the second grid cell, v_{z} (k) is a z-axis component of the velocity vector of the second grid cell, and both T₁ and T₂ are non-negative thresholds.

For an implementation principle of this implementation, refer to the descriptions of manner 1 and manner 2 of determining the grid cell that is in the velocity grid W₁ and that corresponds to one piece of measurement data in the foregoing method embodiments. Details are not described herein again.

In an optional implementation, a manner in which the first processing module 901 determines the weight of the grid cell in the velocity grid W₁ based on the measurement data from the sensor includes:

determining a second grid cell (i, j) based on an n^{th} piece of measurement data, and weighting the second grid cell (i, j) based on a weighted increment or weighting factor, where a velocity vector corresponding to the second grid cell (i, j) satisfies

|vₓ(i)·cosθₙ+v_{y}(j)·sinθₙ−\dot{r}ₙ|≤T₁; or

determining a second grid cell (i, j, k) based on an n^{th} piece of measurement data, and weighting the second grid cell (i, j, k) based on a weighted increment or weighting factor, where a velocity vector corresponding to the second grid cell (i, j, k) satisfies

|vₓ(i)·cosφₙcosθₙ+v_{y}(j)·sinφₙsinθₙ+v_{z}(k)·sinφₙ−\dot{r}ₙ|≤T₂, where

θₙ is a measurement value of an azimuth angle included in the n^{th} piece of measurement data, φₙ is a measurement value of a pitch angle included in the n^{th} piece of measurement data, \dot{r}ₙ is a measurement value of a radial velocity included in the n^{th} piece of measurement data, vₓ (i) is an x-axis component of the velocity vector corresponding to the second grid cell, v_{y} (j) is a y-axis component of the velocity vector corresponding to the second grid cell, v_{z} (k) is a z-axis component of the velocity vector of the second grid cell, and both T₁ and T₂ are non-negative thresholds.

For an implementation principle of this implementation, refer to the descriptions of manner 3 and manner 4 of determining the grid cell that is in the velocity grid W₁ and that corresponds to one piece of measurement data in the foregoing method embodiments. Details are not described herein again.

In an optional implementation, the weighted increment or weighting factor of the grid cell in the velocity grid W₁ is a preset value, the weighted increment or weighting factor of the grid cell in the velocity grid W₁ is a value determined based on the n^{th} piece of measurement data, or the weighted increment or weighting factor of the grid cell in the velocity grid W₁ is a value determined based on the n^{th} piece of measurement data and a distribution of a scattering section corresponding to a preset target type.

For an implementation principle of this implementation, refer to the descriptions of determining the weighted increment in the foregoing method embodiments. Details are not described herein again. For example, the weighted increment may be determined according to one or more combinations of formulas (15) to (28), (30) to (44), (46) to (51), and (53) to (58).

In an optional implementation, the first grid cell in the velocity grid W₁ is the grid cell with the largest weight in the velocity grid W₁; and when the velocity grid W₁ has a plurality of grid cells with the largest weight, the first grid cell in the velocity grid W₁ is a grid cell that is among the plurality of grid cells with the largest weight and that corresponds to a largest velocity vector; or when the velocity grid W₁ has a plurality of grid cells with the largest weight, the first grid cell in the velocity grid W₁ is a grid cell that is among the plurality of grid cells with the largest weight and that corresponds to a velocity vector closest to the reference velocity vector.

In an optional implementation, a manner in which the second processing module 902 determines the motion state of the sensor based on the first grid cell in the velocity grid W₁ includes: determining that a velocity vector corresponding to the first grid cell in the velocity grid W₁ is the velocity vector of the sensor.

In an optional implementation, a manner in which the second processing module 902 determines the motion state of the sensor based on the first grid cell in the velocity grid W₁ includes: determining that an opposite number of each velocity component of a velocity vector corresponding to the first grid cell in the velocity grid W₁ is each velocity component of the velocity vector of the sensor.

In an optional implementation, a manner in which the second processing module 902 determines the motion state of the sensor based on the first grid cell in the velocity grid W₁ includes: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, and the weight of the grid cell in the velocity grid Wₘ is determined based on the measurement data from the sensor, where m=1, 2, . . . , M, and M is an integer; and determining that a velocity vector corresponding to the first grid cell in the velocity grid W_{M} is the velocity vector of the sensor.

In an optional implementation, a manner in which the second processing module 902 determines the motion state of the sensor based on the first grid cell in the velocity grid W₁ includes: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, and the weight of the grid cell in the velocity grid Wₘ is determined based on the measurement data from the sensor, where m=1, 2, . . ., M, and M is an integer; and determining that the opposite number of each velocity component of a velocity vector corresponding to the first grid cell in the velocity grid W_{M} is each velocity component of the velocity vector of the sensor.

In an optional implementation, the motion state determining apparatus further includes a third processing module, configured to determine measurement data of a target stationary relative to a reference system from the measurement data based on the velocity vector of the sensor.

In an optional implementation, a manner in which the second processing module 902 determines the motion state of the sensor based on the first grid cell in the velocity grid W₁ includes: determining, based on a velocity vector corresponding to the first grid cell in the velocity grid W₁, measurement data of a target stationary relative to the reference system from the measurement data; and determining the velocity vector of the sensor based on the measurement data of the target stationary relative to the reference system.

In an optional implementation, a manner in which the second processing module 902 determines the velocity vector of the sensor based on the measurement data of the target stationary relative to the reference system is specifically: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, the weight of the grid cell in the velocity grid Wₘ is determined based on newly determined measurement data of the target stationary relative to the reference system, and the newly determined measurement data of the target stationary relative to the reference system is determined based on the velocity vector corresponding to the first grid cell in the velocity grid Wₘ₋₁, where m=1, 2, . . . , M, and M is an integer; and determining that a velocity vector corresponding to the first grid cell in the velocity grid W_{M} is the velocity vector of the sensor.

In an optional implementation, a manner in which the second processing module 902 determines the velocity vector of the sensor based on the measurement data of the target stationary relative to the reference system includes: determining a first grid cell in a velocity grid Wₘ, where the velocity grid Wₘ includes a plurality of grid cells, each grid cell in the velocity grid Wₘ corresponds to one velocity vector, the velocity vector corresponding to the grid cell in the velocity grid Wₘ includes at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, the weight of the grid cell in the velocity grid Wₘ is determined based on newly determined measurement data of the target stationary relative to the reference system, and the newly determined measurement data of the target stationary relative to the reference system is determined based on the velocity vector corresponding to the first grid cell in the velocity grid Wₘ₋₁, where m=1, 2, . . . , M, and M is an integer; and determining that an opposite number of each velocity component of a velocity vector corresponding to the first grid cell in the velocity grid W_{M} is each velocity component of the velocity vector of the sensor.

In an optional implementation, the second processing module 902 determines the velocity vector of the sensor according to the following measurement equation:

−\dot{r}ₖ=hₖvₛ−n_{\dot{r}}, where

\dot{r}ₖ is a measurement value of a radial velocity of a k^{th} target stationary relative to the reference system; vₛ is the velocity vector of the sensor; n is a measurement error of the radial velocity \dot{r}ₖ; and when a velocity vector corresponding to each grid cell in the velocity grid W₁ includes two velocity components, hₖ=[cosθₖ sinθₖ], or when a velocity vector corresponding to each grid cell in the velocity grid W₁ includes three velocity components, hₖ=[cosφₖ cosθₖ cosφₖ sinθₖ sinφₖ], where φₖ is a measurement value of a pitch angle of the k^{th} target stationary relative to the reference system, and θₖ is a measurement value of an azimuth angle of the k^{th} target stationary relative to the reference system.

For an implementation principle of this implementation, refer to the corresponding descriptions of determining the velocity vector in the foregoing method embodiments. Details are not described herein again.

In an optional implementation, the second processing module 902 determines the velocity vector of the sensor according to the following measurement equation:

\dot{r}ₖ=hₖv_{T}+n_{\dot{r}}, where

\dot{r}ₖ is a measurement value of a radial velocity of a k^{th} target stationary relative to the reference system; vₛ is the velocity vector of the sensor; n_{\dot{r}} is a measurement error of the radial velocity \dot{r}ₖ; and when a velocity vector corresponding to each grid cell in the velocity grid W₁ includes two velocity components, hₖ=[cosθₖ sinθₖ], salt or when a velocity vector corresponding to each grid cell in the velocity grid W₁ includes three velocity components, hₖ[cosφₖ cosθₖ cosφₖ sinθₖ sinφₖ ], where φₖ is a measurement value of a pitch angle of the k^{th} target stationary relative to the reference system, and θₖ is a measurement value of an azimuth angle of the k^{th} target stationary relative to the reference system.

For an implementation principle of this implementation, refer to the corresponding descriptions of determining the velocity vector in the foregoing method embodiments. Details are not described herein again.

In an optional implementation, an exemple implementation of determining the velocity vector of the sensor according to the measurement equation includes: obtaining the velocity vector of the sensor according to the measurement equation and based on a least square method and/or sequential block filtering.

For an implementation principle of this implementation, refer to the descriptions of obtaining the velocity vector of the sensor based on the least square method and/or sequential block filtering in the foregoing method embodiments. Details are not described herein again. For example, refer to the descriptions corresponding to formulas (67) to (92).

In an optional implementation, an example implementation of determining the motion state of the sensor based on the first grid cell in the velocity grid W₁ includes: determining the velocity vector of the sensor based on a velocity vector corresponding to the first grid cell in the velocity grid W₁, a velocity vector corresponding to the first grid cell in the velocity grid Wₘ, or a velocity vector of the sensor estimated based on the measurement data of the target stationary relative to the reference system and a first velocity vector. The first velocity vector includes a velocity vector of the sensor determined based on measurement data of a previous frame and/or a reference velocity vector of the sensor, where the reference velocity vector of the sensor may be a velocity vector of the sensor measured by an IMU or another apparatus.

Based on a same inventive concept, the problem-resolving principle of the motion state determining apparatus provided in this application is similar to the principle of the method embodiments of this application. Therefore, for the implementation principles of the apparatus, refer to the implementation principles of the method. For brief description, details are not described herein again.

FIG. 10 is a schematic structural diagram of a motion state determining apparatus disclosed in an embodiment of this application. As shown in FIG. 10, the motion state determining apparatus includes a processor 1001, a memory 1002, and a communication interface 1003. The processor 1001, the memory 1002, and the communication interface 1003 are connected.

The processor 1001 may be a central processing unit (CPU), a general-purpose processor, a coprocessor, a digital signal processor (DSP), an application-specific integrated circuit (ASIC), or a field programmable gate array (FPGA) or another programmable logic device, a transistor logic device, a hardware component, or any combination thereof. Alternatively, the processor 1001 may be a combination for implementing a computing function, for example, a combination of one or more microprocessors, or a combination of a DSP and a microprocessor.

The communication interface 1003 is configured to implement communication with another device or another communication component in the same motion state determining apparatus.

The processor 1001 invokes program code stored in the memory 1002, to perform steps performed by the motion state determining apparatus in the foregoing method embodiments. The memory 1002 is further configured to store cached data in a process of performing the foregoing method. The memory 1002 and the processor 1001 are coupled to each other, or optionally, may be integrated together. The first processing module, the second processing module, and the third processing module may be implemented by using the processor 1001.

An embodiment of the present invention further provides a computer-readable storage medium. The computer-readable storage medium stores instructions. When the instructions are run on a processor, method procedures in the foregoing method embodiments are implemented.

An embodiment of the present invention further provides a computer program product. When the computer program product runs on a processor, method procedures in the foregoing method embodiments are implemented.

When the apparatus provided in this application is implemented by using software, all or part of the apparatus may be implemented in a form of a computer program product. The computer program product includes one or more computer instructions. When the computer program instructions are loaded and executed on a computer, all or part of the procedures or functions described in the embodiments of this application are implemented. The computer may be a general-purpose computer, a dedicated computer, a computer network, or another programmable apparatus. The computer instructions may be stored in a computer-readable storage medium, or transmitted from one computer-readable storage medium to another. For example, the computer instructions may be transmitted from a website site, computer, server, or data center in a wired (for example, a coaxial cable, an optical fiber, or a digital subscriber line (DSL)) or wireless (for example, infrared, wireless, or microwave) manner to another website, computer, server, or data center. The computer-readable storage medium may be any usable medium that can be accessed by the computer, or a data storage device such as a server or a data center that integrates one or more usable media. The usable medium may be a magnetic medium (for example, a floppy disk, a hard disk, or a magnetic tape), an optical medium (for example, a DVD), a semiconductor medium (for example, a solid state drive (SSD)), or the like.

An embodiment of this application further provides a chip system. The chip system includes a processor, configured to support a motion state determining apparatus to implement the functions in the foregoing embodiments, for example, generating or processing the data and/or information in the foregoing method. Optionally, the chip system further includes an interface circuit, and the processor obtains information or outputs information by using the interface circuit. It should be noted herein that the chip system may be an integrated circuit. Further, the integrated circuit includes at least one transistor and/or at least one logic gate.

Further, optionally, the chip system may further include a memory. The memory is configured to store necessary program instructions and data. The processor may invoke and execute the program instructions, to implement the method provided in this application. The chip system may include a chip, or may include a chip and other devices.

Based on a same inventive concept, a problem-resolving principle of the motion state determining apparatus provided in this application is similar to the principle of the motion state determining apparatus in the method embodiments of this application. Therefore, for implementation of each device, refer to the implementation of the method. For brief description, details are not described herein again.

In the foregoing embodiments, descriptions of each embodiment have different emphases. For a part that is not described in detail in an embodiment, refer to related descriptions of other embodiments. Finally, it should be noted that: the foregoing embodiments are merely used to describe the technical solutions of this application, but not to limit them. Although this application has been described in detail with reference to the foregoing embodiments, a person of ordinary skill in the art should understand that the technical solutions described in the foregoing embodiments may still be modified, or some or all technical features thereof may be equivalently replaced. However, these modifications or replacements do not make the essence of the corresponding technical solutions fall out of the protection scope of the technical solutions in the embodiments of this application.

What is claimed is:

1. A motion state determining method, wherein the method comprises:
determining a weight of a grid cell in a velocity grid W₁ based on measurement data from a sensor, wherein the velocity grid W₁ comprises a plurality of grid cells, each grid cell in the plurality of grid cells corresponds to one velocity vector, each velocity vector comprises at least one velocity component, and the measurement data comprises a velocity measurement value; and
determining a motion state of the sensor based on the weight of the grid cell, wherein the motion state of the sensor comprises a velocity vector of the sensor, and the velocity vector of the sensor comprises at least one velocity component.

2. The method according to claim 1, wherein the velocity grid W₁ is determined based on at least one of a resolution cell size and a reference velocity vector.

3. The method according to claim 2, wherein the velocity grid W₁ is determined based further on at least one of a resolution cell quantity, a minimum velocity of a velocity component, or a velocity range of the velocity component.

4. The method according to claim 1, wherein the determining a motion state of the sensor based on the weight of the grid cell comprises:
determining the motion state of the sensor based on a first grid cell in the velocity grid W₁, wherein the first grid cell in the velocity grid W₁ is a grid cell with a largest weight in the velocity grid W₁, the first grid cell in the velocity grid W₁ is a grid cell that is in a neighborhood of a grid cell with a largest weight in the velocity grid W₁ and that is closest to the reference velocity vector, or the first grid cell in the velocity grid W₁ is a grid cell that is among a plurality of grid cells with maximum weights in the velocity grid W₁ and that corresponds to a velocity vector closest to the reference velocity vector.

5. The method according to claim 1, wherein the determining a weight of a grid cell in a velocity grid W₁ based on measurement data from a sensor comprises:
determining a second grid cell (i, j) based on an n^{th} piece of measurement data, and weighting the second grid cell (i, j) based on a weighted increment or weighting factor, wherein a velocity vector corresponding to the second grid cell (i, j) satisfies

|vₛ(i)·cosθₙ+v_{y}(j)·sinθn+\dot{r}ₙ|≤T₁; or
determining a second grid cell (i, j, k) based on an n^{th} piece of measurement data, and weighting the second grid cell (i, j, k) based on a weighted increment or weighting factor, wherein a velocity vector corresponding to the second grid cell (i, j, k) satisfies

|vₓ(i)·cosφₙ cosθₙ+v_{y}(j)·sinφₙ sinθₙ+v_{z}(k)·sinφₙ+\dot{r}ₙ|≤T₂, wherein
θₙ is a measurement value of an azimuth angle comprised in the n^{th} piece of measurement data, φₙ is a measurement value of a pitch angle comprised in the n^{th} piece of measurement data, \dot{r}ₙ is a measurement value of a radial velocity comprised in the n^{th} piece of measurement data, vₓ (i) is an x-axis component of the velocity vector corresponding to the second grid cell, v_{y} (j) is a y-axis component of the velocity vector corresponding to the second grid cell, v_{z} (k) is a z-axis component of the velocity vector of the second grid cell, and both T₁ and T₂ are non-negative thresholds.

6. The method according to claim 1, wherein the weighted increment or weighting factor of the grid cell in the velocity grid W₁ is a preset value, the weighted increment or weighting factor of the grid cell in the velocity grid W₁ is a value determined based on the n^{th} piece of measurement data, or the weighted increment or weighting factor of the grid cell in the velocity grid W₁ is a value determined based on the n^{th} piece of measurement data and a distribution of a scattering section corresponding to a preset target type.

7. The method according to claim 4, wherein the first grid cell in the velocity grid W₁ is the grid cell with the largest weight in the velocity grid W₁; and
when the velocity grid W₁ has a plurality of grid cells with the largest weight, the first grid cell in the velocity grid W₁ is a grid cell that is among the plurality of grid cells with the largest weight and that corresponds to a largest velocity vector; or
when the velocity grid W₁ has a plurality of grid cells with the largest weight, the first grid cell in the velocity grid W₁ is a grid cell that is among the plurality of grid cells with the largest weight and that corresponds to a velocity vector closest to the reference velocity vector.

8. The method according to claim 4, wherein the determining the motion state of the sensor based on a first grid cell in the velocity grid W₁ comprises:
determining that a velocity vector corresponding to the first grid cell in the velocity grid W₁ is the velocity vector of the sensor.

9. The method according to claim 4, wherein the determining the motion state of the sensor based on a first grid cell in the velocity grid W₁ comprises:
determining a first grid cell in a velocity grid Wₘ, wherein the velocity grid Wₘ comprises a plurality of grid cells, each grid cell in the velocity grid Wₘ corresponds to one velocity vector, the velocity vector corresponding to the grid cell in the velocity grid Wₘ comprises at least one velocity component, the velocity grid Wₘ is determined based on a reference velocity vector and a resolution cell size of the velocity grid Wₘ in each dimension, the reference velocity vector is a velocity vector corresponding to a first grid cell in a velocity grid Wₘ₋₁, the resolution cell size of the velocity grid Wₘ is less than or equal to a resolution cell size of the velocity grid Wₘ₋₁, the first grid cell in the velocity grid Wₘ is determined based on a weight of a grid cell in the velocity grid Wₘ, and the weight of the grid cell in the velocity grid Wₘ is determined based on the measurement data from the sensor, wherein m=1, 2, . . . , M, and M is an integer; and
determining that a velocity vector corresponding to the first grid cell in the velocity grid W_{M} is the velocity vector of the sensor.

10. The method according to claim 1, wherein the method further comprises:
determining measurement data of a target stationary relative to a reference system from the measurement data based on the velocity vector of the sensor.

11. An apparatus, comprising:
one or more processors, and
a storage medium in communication with the one or more processors, the storage medium configured to store program instructions, wherein, when executed by the one or more processors, the instructions cause the apparatus to perform:
determining a weight of a grid cell in a velocity grid W₁ based on measurement data from a sensor, wherein the velocity grid W₁ comprises a plurality of grid cells, each grid cell in the plurality of grid cells corresponds to one velocity vector, each velocity vector comprises at least one velocity component, and the measurement data comprises a velocity measurement value; and
determining a motion state of the sensor based on the weight of the grid cell, wherein the motion state of the sensor comprises a velocity vector of the sensor, and the velocity vector of the sensor comprises at least one velocity component.

12. The apparatus according to claim 11, wherein the velocity grid W₁ is determined based on at least one of a resolution cell size and a reference velocity vector.

13. The apparatus according to claim 12, wherein the velocity grid W₁ is determined further based on at least one of a resolution cell quantity, a minimum velocity of a velocity component, and a range of the velocity component.

14. The apparatus according to claim 11, wherein the determining of the motion state of the sensor based on the weight of the grid cell further comprises:
determining the motion state of the sensor based on a first grid cell in the velocity grid W₁, wherein the first grid cell in the velocity grid W₁ is a grid cell with a largest weight in the velocity grid W₁, the first grid cell in the velocity grid W₁ is a grid cell that is in a neighborhood of a grid cell with a largest weight in the velocity grid W₁ and that is closest to the reference velocity vector, or the first grid cell in the velocity grid W₁ is a grid cell that is among a plurality of grid cells with maximum weights in the velocity grid W₁ and that corresponds to a velocity vector closest to the reference velocity vector.

15. The apparatus according to claim 11, wherein the determining of the weight of the grid cell in the velocity grid W₁ based on the measurement data from the sensor further comprises:
determining a second grid cell (i, j) based on an n^{th} piece of measurement data, and weighting the second grid cell (i, j) based on a weighted increment or weighting factor, wherein a velocity vector corresponding to the second grid cell (i, j) satisfies

|vₓ(i)·cosθₙ+v_{y}(j)·sinθₙ+\dot{r}ₙ|≤T₁; or
determining a second grid cell (i, j, k) based on an n^{th} piece of measurement data, and weighting the second grid cell (i, j, k) based on a weighted increment or weighting factor, wherein a velocity vector corresponding to the second grid cell (i, j, k) satisfies

|vₓ(i)·cosφₙcosθₙ+v_{y}(j)·sinφₙ sinθₙ+v_{z}(k)·sinφₙ+\dot{r}ₙ|≤T₂, wherein
θₙ is a measurement value of an azimuth angle comprised in the n^{th} piece of measurement data, φₙ is a measurement value of a pitch angle comprised in the n^{th} piece of measurement data, \dot{r}ₙ is a measurement value of a radial velocity comprised in the n^{th} piece of measurement data, vₓ (i) is an x-axis component of the velocity vector corresponding to the second grid cell, v_{y} (j) is a y-axis component of the velocity vector corresponding to the second grid cell, v_{z} (k) is a z-axis component of the velocity vector of the second grid cell, and both T₁ and T₂ are non-negative thresholds.

16. The apparatus according to claim 15, wherein the weighted increment or weighting factor of the grid cell in the velocity grid W₁ is a preset value, the weighted increment or weighting factor of the grid cell in the velocity grid W₁ is a value determined based on the n^{th} piece of measurement data, or the weighted increment or weighting factor of the grid cell in the velocity grid W₁ is a value determined based on the n^{th} piece of measurement data and a distribution of a scattering section corresponding to a preset target type.

17. The apparatus according to claim 14, wherein the first grid cell in the velocity grid W₁ is the grid cell with the largest weight in the velocity grid W₁; and
when the velocity grid W₁ has a plurality of grid cells with the largest weight, the first grid cell in the velocity grid W₁ is a grid cell that is among the plurality of grid cells with the largest weight and that corresponds to a largest velocity vector; or
when the velocity grid W₁ has a plurality of grid cells with the largest weight, the first grid cell in the velocity grid W₁ is a grid cell that is among the plurality of grid cells with the largest weight and that corresponds to a velocity vector closest to the reference velocity vector.

18. The apparatus according to claim 14, wherein the determining the motion state of the sensor based on the first grid cell in the velocity grid W₁ further comprises:
determining that a velocity vector corresponding to the first grid cell in the velocity grid W₁ is the velocity vector of the sensor.

19. A non-transitory computer readable medium, wherein the non-transitory computer readable medium stores program instructions, and when the program instructions are executed by a processor, the processor is enabled to perform the method of:
determining a weight of a grid cell in a velocity grid W₁ based on measurement data from a sensor, wherein the velocity grid W₁ comprises a plurality of grid cells, each grid cell in the plurality of grid cells corresponds to one velocity vector, each velocity vector comprises at least one velocity component, and the measurement data comprises a velocity measurement value; and
determining a motion state of the sensor based on the weight of the grid cell, wherein the motion state of the sensor comprises a velocity vector of the sensor, and the velocity vector of the sensor comprises at least one velocity component.
